(19) United States
(12) Patent Application Publication
(10) Pub. No.: US 2025/0191004 A1
(43) Pub. Date: Jun. 12, 2025

(54) CUSTOMER LIFETIME VALUE MODEL FOR WIRELESS SUBSCRIBERS

(71) Applicant: DISH Wireless L.L.C., Englewood, CO (US)

(72) Inventors: Kalleri Faizel Rehiman, Fremont, CA (US); Sisong Bei, Dublin, CA (US); Qi Chu, San Mateo, CA (US); Christine Michelle Chu, San Francisco, CA (US); Madhukar Pulluru, Foster City, CA (US); Mikhail Leonidovich Arbuzov, Santa Clara, CA (US)

(21) Appl. No.: 18/533,051

(22) Filed: Dec. 7, 2023

(51) Int. Cl. G06Q 30/0201

(52) U.S. Cl. CPC G06Q 30/0201

(57) ABSTRACT

A method includes identifying one or more features corresponding to a wireless subscriber associated with a wireless service provider. The method also includes predicting, based on the one or more features corresponding to the wireless subscriber and using one or more machine learning models, one or more parameters associated with future engagement of the wireless subscriber with the wireless service provider. The method also includes determining a score that is indicative of an expected profitability associated with the wireless subscriber based on the one or more parameters associated with future engagement of the wireless subscriber with the wireless service provider. The method also includes determining that the score satisfies a threshold condition, and responsive to determining that the score satisfies the threshold condition, performing one or more actions to decrease a probability that the wireless subscriber churns.

### TECHNICAL FIELD

The description generally relates to machine learning-based techniques for managing wireless networks and managing customer relationships with wireless customers (e.g., subscribers to a 4G or 5G network provider), including the expansion of wireless networks and the acquisition of new wireless customers.

### BACKGROUND

Cellular networks (e.g., cellular radio access networks, cellular core networks, etc.) are telecommunications networks that include a number of distributed devices that send, receive, and/or process wireless signals across the network to provide coverage to a geographical area. For example, in 5G networks, these devices can include wireless equipment called “small cells” or “cells,” which can be installed at wireless towers distributed throughout the geographic area. Users (e.g., wireless customers, wireless subscribers, roaming users, etc.) can connect to these cells in order to access the network, and they often pay a provider of the cellular network (e.g., in accordance with a data plan or contract) to use a certain amount data (including unlimited data) on the network.

### SUMMARY

This document describes techniques for collecting data about the use of a cellular network by various users and processing the data for several different applications. In one implementation, the data can be used to train one or more models (e.g., one or more machine learning models) that estimate, for a single user or for a cohort of users, (i) a predicted payment amount to be made by one or more users to a network provider, (ii) a predicted cost to the network provider associated with servicing the one or more users, and (iii) a predicted churn rate for the one or more users. The one or more models can be trained to make these estimates based on data about the one or more users (or other similar users) including payment data, data usage information, information about costs associated with providing services to the users, a type of device of the one or more users, a type of data plan associated with the users, a longevity of a business relationship with the users, and/or demographic features of the users. The model-generated estimates of the predicted payment amount, the predicted cost, and the predicted churn rate can be combined to generate a metric indicative of a future profitability (e.g., to a network provider) associated with the one or more users. This profitability metric can be referred to as a “customer lifetime value” (CLV) for the one or more users. As described in this specification, CLV can be a useful metric for informing decisions and actions of a network provider as the network provider manages a wireless network and/or manages relationships with users of the wireless network (e.g., wireless customers, subscribers, etc.).

In some cases, CLV can be used to assign additional data usage quotas to users of a wireless network. For example, a user (e.g., a wireless subscriber) may have a data plan with a specified data quota. If that quota is exceeded by the user, the network provider may throttle the user's data usage by limiting internet speeds for the user (known as “bandwidth throttling”) or preventing the user from utilizing the network entirely. Even for users with “unlimited” data plans, existing cellular networks often implement a data threshold beyond which bandwidth throttling is used to prevent overuse of the network. Bandwidth throttling and cutting off network access for a user can save a network provider money in the short-term by limiting costs associated with the user. However, bandwidth throttling and cutting off network access can also contribute to a negative user experience for the user and may cause the user to churn (e.g., ending a relationship with the network provider by switching to a data plan offered by a different network provider). User churn, especially for high-value customers can negatively affect the long-term profits earned by the network provider. Thus, for such high-value customers, a better approach may be the allocation of an additional data usage quota to the customer so that their user experience is not diminished and so that they do not churn. By using CLV to estimate a future profitability of a user, a network provider can gain insight into which customers are high-value customers who should be allocated additional data usage quotas. As described in further detail herein, CLV can also be combined with separately predicted probabilities of churn for specific individuals to provide even more tailored assessments of the potential value at risk to a network provider if said individuals were lost as customers. Additional models for predicting (i) the amount of additional data usage quota that would need to be “gifted” to a user and (ii) a likelihood that gifting the additional data usage quota would prevent the user from churning (e.g., as determined through A/B testing) can also be implemented to determine who should be allocated additional data usage quotas by a network provider.

In some cases, CLV can also be used to select wireless retail locations or locations for installing wireless network infrastructure (e.g., cell towers). Selecting such locations can be based on an aggregate of CLVs for multiple users in a particular geolocation. For example, certain geolocations may be associated with the residence locations or work locations of many high CLV users, and may therefore represent a desirable location for a network provider to establish a retail presence (e.g., to gain new high CLV users and/or to provide better service to existing high CLV users). Similar locations may also represent desirable candidate locations to install wireless network infrastructure (e.g., to provide high-quality network coverage and/or to increase bandwidth in locations with heavy data usage). Thus, within a pre-defined radius from a geolocation, an aggregate CLV for multiple network users can be determined and compared against similarly calculated scores for other geolocations. If the aggregate CLV for a particular geolocation is relatively high or if it exceeds a threshold level, then the network provider might prioritize the establishment of a retail location or the installation of wireless network equipment at the geolocation.

In some cases, a network provider may be interested in establishing wireless retail locations or installing wireless network infrastructure in locations where the network provider does not already have many customers. In such cases, it may not be possible to estimate a CLV value for pre-existing customers within a pre-defined radius from a candidate location because such customers may not exist (or may be too few in numbers to yield reliable usage and/or financial data). However, to overcome this challenge, one or more models (e.g., one or more machine learning models) can be trained to estimate an expected profitability (e.g., an expected aggregate CLV) associated with the candidate location based on demographic information about the location. In other words, based on estimating aggregate CLV values for other geolocations where user data is readily available, the one or models may identify patterns within the data to make profitability predictions about geolocations where user data is not available. For example, if it is observed that in many geolocations, an increasing proportion of 20-30 year old software engineers correlates with increased aggregate CLVs, then the one or more models might predict that a new geolocation dominated by 20-30 year old software engineers would also have a high aggregate CLV, even if the network provider currently has no customers in the new geolocation. In this way, a network provider can leverage CLV to identify new retail locations and locations for wireless network infrastructure, thereby expanding its customer base and/or network coverage.

Various implementations of the technology described herein may provide one or more of the following advantages. First, accurate predictions of payments, costs, and churn probability for users can enable network providers to focus its efforts on retaining and attracting high-value customers who are most likely to influence profitability. Second, by enabling network providers to intelligently determine whom to gift additional data usage quotas (and how much data to gift them), the technology described herein can improve the user experience for high-value customers (including those with “unlimited” data plans) and reduce churn while adhering to the technical constraints (e.g., bandwidth limitations) of a cellular network. A third advantage of the technology described in this specification is the efficient allocation of a network provider's resources to establish new wireless retail locations and to install new wireless infrastructure equipment, enabling improved customer service, network coverage, and customer base expansion.

In one aspect, a method is featured. The method includes identifying one or more features corresponding to a wireless subscriber associated with a wireless service provider. The method also includes predicting, based on the one or more features corresponding to the wireless subscriber and using one or more machine learning models, one or more parameters associated with future engagement of the wireless subscriber with the wireless service provider. The method also includes determining a score that is indicative of an expected profitability associated with the wireless subscriber based on the one or more parameters associated with future engagement of the wireless subscriber with the wireless service provider. The method also includes determining that the score satisfies a threshold condition, and responsive to determining that the score satisfies the threshold condition, performing one or more actions to decrease a probability that the wireless subscriber churns.

Implementations can include the examples described below and herein elsewhere. In some implementations, the one or more parameters associated with future engagement of the wireless subscriber with the wireless service provider can include (i) at least one future payment from the wireless subscriber, (ii) at least one future cost associated with providing services to the wireless subscriber, and (iii) at least one future churn probability associated with the wireless subscriber. In some implementations, the one or more features corresponding to the wireless subscriber can include historical payments made by the wireless subscriber, historical data usage, historical costs associated with providing services to the wireless subscriber, a type of device of the wireless subscriber, a type of data plan associated with the wireless subscriber, a longevity of a business relationship with the wireless subscriber, and/or demographic features of the wireless subscriber. In some implementations, the method can include classifying the wireless subscriber into one of a plurality of cohorts based on the one or more features corresponding to the wireless subscriber, and selecting the one or more machine learning models for use based on the classification of the wireless subscriber. In some implementations, the one or more parameters associated with future engagement of the wireless subscriber with the wireless service provider can correspond to a length of time between 1 day and 48 months subsequent to the predicting. In some implementations, the score that is indicative of the expected profitability associated with the wireless subscriber can correspond to a length of time between 1 day and 48 months subsequent to determining the score. In some implementations, the one or more machine learning models can be trained using data about other wireless subscribers, wherein the data includes historical payments made by the other wireless subscribers, historical data usage, historical costs associated with providing services to the other wireless subscribers, churn rates of the other wireless subscribers a type of device of the other wireless subscribers, a type of data plan associated with the other wireless subscribers, a longevity of a business relationship with the other wireless subscribers, and/or demographic features of the other wireless subscribers. In some implementations, the one or more machine learning models can be trained by: splitting the data about the other wireless subscribers into cohort-specific data subsets based on a cohort classification associated with each individual of the other wireless subscribers, and training the one or more machine learning models using one of the cohort-specific data subsets. In some implementations, the method can include determining a value at risk associated with the wireless subscriber, wherein determining the value at risk is based on the determined score and a predicted line churn probability associated with the wireless subscriber. In some implementations, the predicted line churn probability can be output by an additional machine learning model that is distinct from the one or more machine learning models.

In another aspect, a computing system is featured. The computing system includes a memory configured to store instructions and one or more processors configured to execute the instructions to perform operations. The operations include identifying one or more features corresponding to a wireless subscriber associated with a wireless service provider. The operations also include predicting, based on the one or more features corresponding to the wireless subscriber and using one or more machine learning models, one or more parameters associated with future engagement of the wireless subscriber with the wireless service provider. The operations also include determining a score that is indicative of an expected profitability associated with the wireless subscriber based on the one or more parameters associated with future engagement of the wireless subscriber with the wireless service provider. The operations also include determining that the score satisfies a threshold condition, and responsive to determining that the score satisfies the threshold condition, performing one or more actions to decrease a probability that the wireless subscriber churns.

Implementations can include the examples described below and herein elsewhere. In some implementations, the one or more parameters associated with future engagement of the wireless subscriber with the wireless service provider can include (i) at least one future payment from the wireless subscriber, (ii) at least one future cost associated with providing services to the wireless subscriber, and (iii) at least one future churn probability associated with the wireless subscriber. In some implementations, the one or more features corresponding to the wireless subscriber can include historical payments made by the wireless subscriber, historical data usage, historical costs associated with providing services to the wireless subscriber, a type of device of the wireless subscriber, a type of data plan associated with the wireless subscriber, a longevity of a business relationship with the wireless subscriber, and/or demographic features of the wireless subscriber. In some implementations, the operations can include classifying the wireless subscriber into one of a plurality of cohorts based on the one or more features corresponding to the wireless subscriber, and selecting the one or more machine learning models for use based on the classification of the wireless subscriber. In some implementations, the one or more parameters associated with future engagement of the wireless subscriber with the wireless service provider can correspond to a length of time between 1 day and 48 months subsequent to the predicting. In some implementations, the score that is indicative of the expected profitability associated with the wireless subscriber can correspond to a length of time between 1 day and 48 months subsequent to determining the score. In some implementations, the one or more machine learning models can be trained using data about other wireless subscribers, wherein the data includes historical payments made by the other wireless subscribers, historical data usage, historical costs associated with providing services to the other wireless subscribers, churn rates of the other wireless subscribers a type of device of the other wireless subscribers, a type of data plan associated with the other wireless subscribers, a longevity of a business relationship with the other wireless subscribers, and/or demographic features of the other wireless subscribers. In some implementations, the one or more machine learning models can be trained by: splitting the data about the other wireless subscribers into cohort-specific data subsets based on a cohort classification associated with each individual of the other wireless subscribers, and training the one or more machine learning models using one of the cohort-specific data subsets. In some implementations, the operations can include determining a value at risk associated with the wireless subscriber, wherein determining the value at risk is based on the determined score and a predicted line churn probability associated with the wireless subscriber. In some implementations, the predicted line churn probability can be output by an additional machine learning model that is distinct from the one or more machine learning models.

In another aspect, one or more machine-readable storage devices are featured. The one or more machine-readable storage devices have encoded thereon computer readable instructions for causing one or more processing devices to perform operations. The operations include identifying one or more features corresponding to a wireless subscriber associated with a wireless service provider. The operations also include predicting, based on the one or more features corresponding to the wireless subscriber and using one or more machine learning models, one or more parameters associated with future engagement of the wireless subscriber with the wireless service provider. The operations also include determining a score that is indicative of an expected profitability associated with the wireless subscriber based on the one or more parameters associated with future engagement of the wireless subscriber with the wireless service provider. The operations also include determining that the score satisfies a threshold condition, and responsive to determining that the score satisfies the threshold condition, performing one or more actions to decrease a probability that the wireless subscriber churns.

Implementations can include the examples described below and herein elsewhere. In some implementations, the one or more parameters associated with future engagement of the wireless subscriber with the wireless service provider can include (i) at least one future payment from the wireless subscriber, (ii) at least one future cost associated with providing services to the wireless subscriber, and (iii) at least one future churn probability associated with the wireless subscriber. In some implementations, the one or more features corresponding to the wireless subscriber can include historical payments made by the wireless subscriber, historical data usage, historical costs associated with providing services to the wireless subscriber, a type of device of the wireless subscriber, a type of data plan associated with the wireless subscriber, a longevity of a business relationship with the wireless subscriber, and/or demographic features of the wireless subscriber. In some implementations, the operations can include classifying the wireless subscriber into one of a plurality of cohorts based on the one or more features corresponding to the wireless subscriber, and selecting the one or more machine learning models for use based on the classification of the wireless subscriber. In some implementations, the one or more parameters associated with future engagement of the wireless subscriber with the wireless service provider can correspond to a length of time between 1 day and 48 months subsequent to the predicting. In some implementations, the score that is indicative of the expected profitability associated with the wireless subscriber can correspond to a length of time between 1 day and 48 months subsequent to determining the score. In some implementations, the one or more machine learning models can be trained using data about other wireless subscribers, wherein the data includes historical payments made by the other wireless subscribers, historical data usage, historical costs associated with providing services to the other wireless subscribers, churn rates of the other wireless subscribers a type of device of the other wireless subscribers, a type of data plan associated with the other wireless subscribers, a longevity of a business relationship with the other wireless subscribers, and/or demographic features of the other wireless subscribers. In some implementations, the one or more machine learning models can be trained by: splitting the data about the other wireless subscribers into cohort-specific data subsets based on a cohort classification associated with each individual of the other wireless subscribers, and training the one or more machine learning models using one of the cohort-specific data subsets. In some implementations, the operations can include determining a value at risk associated with the wireless subscriber, wherein determining the value at risk is based on the determined score and a predicted line churn probability associated with the wireless subscriber. In some implementations, the predicted line churn probability can be output by an additional machine learning model that is distinct from the one or more machine learning models.

Other features and advantages of the description will become apparent from the following description, and from the claims. Unless otherwise defined, the technical and scientific terms used herein have the same meaning as commonly understood by one of ordinary skill in the art to which this invention belongs.

### BRIEF DESCRIPTION OF DRAWINGS

FIG. 1 shows a process for estimating customer lifetime value (CLV) for wireless subscribers.

FIG. 2 shows a process for determining the value at risk associated with the potential loss of particular wireless subscribers.

FIG. 3 shows a process for determining whether or not to apply a treatment to a particular wireless subscriber.

FIG. 4 shows a process for estimating a likely treatment effect of applying a treatment to wireless subscribers.

FIG. 5 is a flowchart showing a process for selecting candidate locations for wireless network infrastructure or a retail location.

FIG. 6 shows a visualization of a metric indicative of the estimated lifetime value of various geolocations.

FIG. 7 is a flowchart showing a process for selecting candidate locations for wireless network infrastructure or a retail location.

FIG. 8 is a flowchart showing a process for allocating an additional data usage quota to a wireless subscriber.

FIG. 9 is a flowchart showing a process for determining a score that is indicative of an expected profitability associated with a wireless subscriber.

FIGS. 10-11 are flowcharts showing processes for selecting a geolocation as a candidate location for a retail location.

FIGS. 12-13 are flowcharts showing processes for selecting a geolocation as a candidate location for wireless network infrastructure.

FIG. 14 is a diagram illustrating an example of a computing environment.

### DETAILED DESCRIPTION

Providers of cellular networks, or “network providers,” can collect diverse data about users of their networks (e.g., wireless customers, wireless subscribers, roaming users, etc.) as well as information about the users' network usage. When a user connects a user device to a network (e.g., a 5G network) or a tower within the network, a data session is created. In particular, a tower can have multiple equipment sets, or “cells,” (e.g., tens to hundreds of cells) installed on the tower, which are the network components of the tower to which the user device connects. Once a data session is created, the network is able to communicate with the device (e.g., every 30 minutes, every hour, every three hours, etc.) to determine if the device is still connected. Moreover, after a data session ends (e.g., because the connection to the user device is lost, because the user device has connected to a different tower, etc.), the network provider is able to view various kinds of information about the user and the user's data session such as an identity of a user, an amount of data used, a user device type, a data plan of the user, a cell identification number, a technology being used, a tower type and location, a session start and end time, a session end reason, etc. Similar information can also be collected when a user device connects to the tower to place a call or to send a text message.

In addition to the data gathered above, a network provider can use the coordinates of a cell that the user device connects to for geolocating the user device. With the recent proliferation of 5G towers, the existing tower grid is very dense in certain geographic areas, sometimes enabling geolocation precision of about 500 meters. Combining this location information with the other data accessible to network providers, a geospatial profile can be created for each user of the cellular network. For example, the geospatial profile can include a primary daytime location of the user (e.g., a school location), a primary nighttime location of the user (e.g., a home location), a primary data usage location (e.g., an office location), and/or one or more traveling patterns of the user. As described herein, these geospatial profiles of users, along with the other information accessible to network providers can prove highly valuable, enabling network providers to better manage their wireless networks and relationships with users (e.g., wireless customers, wireless subscribers, etc.), including the expansion of wireless networks and the acquisition of new wireless customers.

### Customer Lifetime Value

One major problem that can be addressed by network providers using the data available to them is the identification of relatively high-value versus low-value customers. In this context, the term “high-value customers” refers to customers who are likely, in the long-term, to contribute more to the profits of the network provider (relative to other customers). The term “low-value customers” refers to customers who are likely, in the long-term, to contribute less to the profits of the network provider (relative to other customers). In order to distinguish high-value customers from low-value customers, a metric of expected profitability is proposed. It is sometimes referred to herein as “customer lifetime value” (CLV).

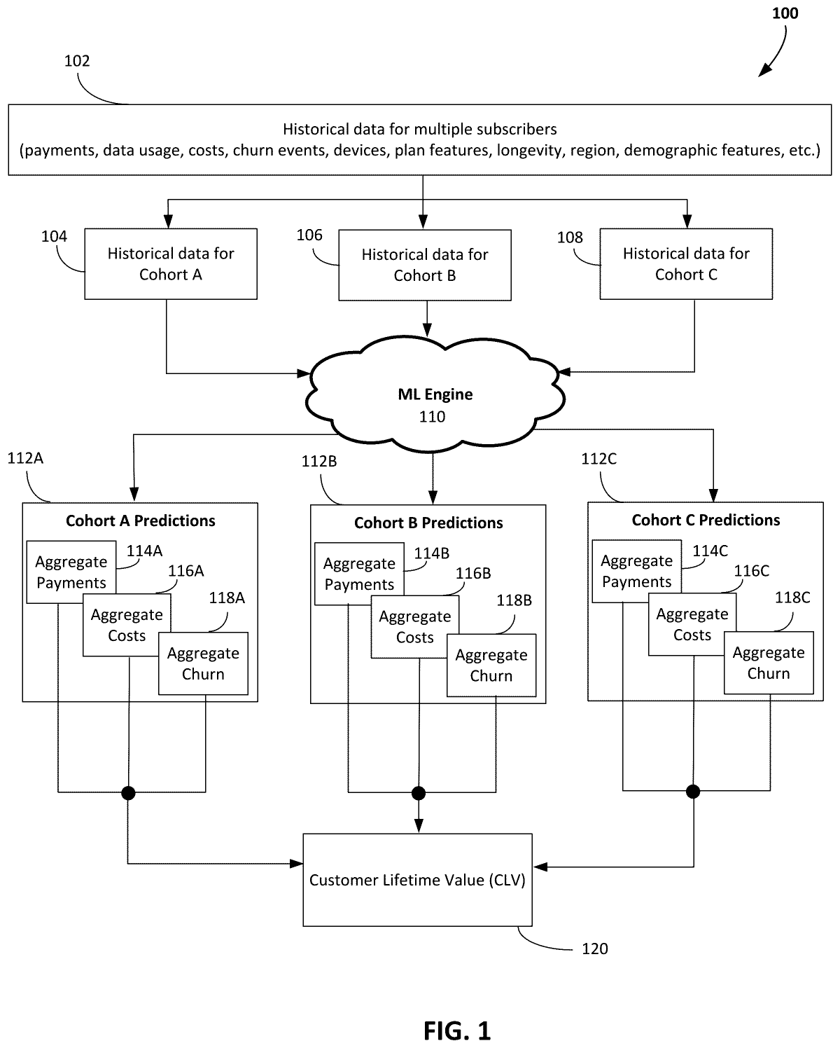

FIG. 1 illustrates a process 100 for estimating CLV for wireless subscribers. At the start of the process 100, one begins with historical data for multiple subscribers 102 (e.g., multiple wireless subscribers to a network provider's cellular network). The historical data for multiple subscribers 102 can include information about payments, data usage, costs to the network provider, churn events, devices, data plan features, longevity, region, demographic features, etc. associated with one or more of the multiple subscribers. In some implementations, the historical data for the multiple subscribers can be stratified into historical data for various cohorts (e.g., historical data for Cohort A 104, historical data for Cohort B 106, historical data for Cohort C 108, etc.). The cohorts can be defined to include similar kinds of users. For example, Cohort A might correspond to subscribers with high-end devices who have been using the carrier's service for more than 4 years, while Cohort B might correspond to subscribers with iPhones who have ported in from other carriers in the past 24 months, and Cohort C might correspond to low-end device users who have just joined the service.

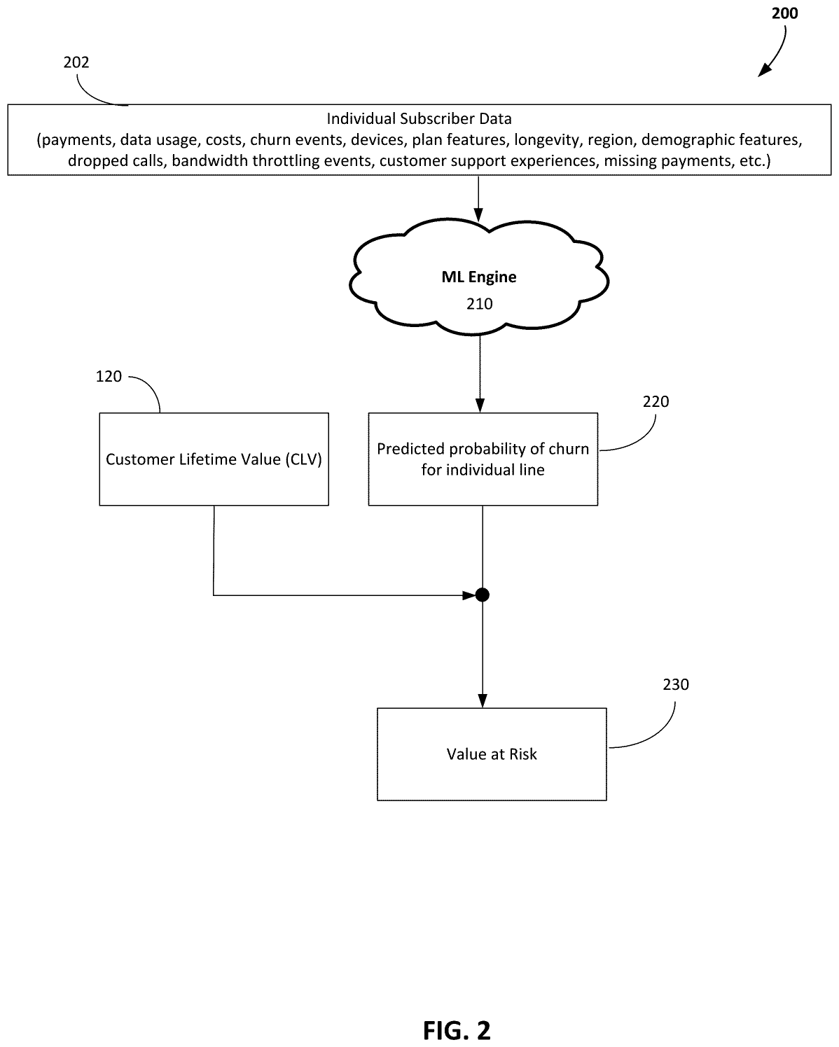

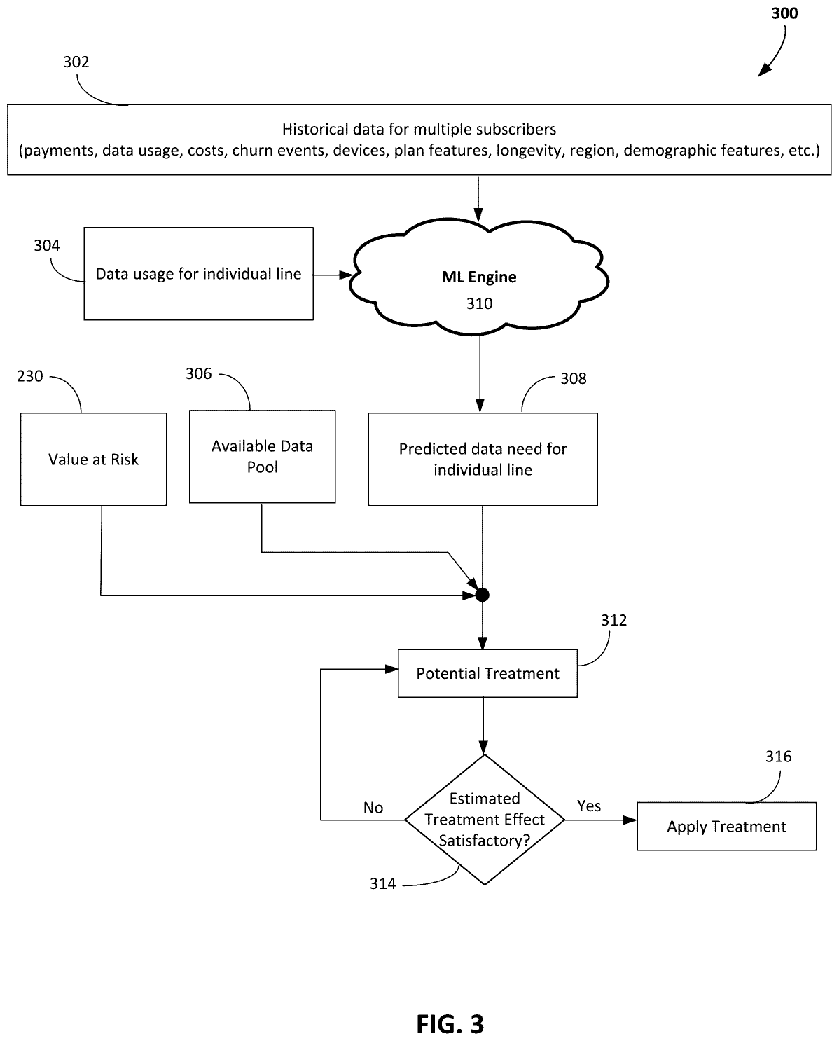

The historical data for Cohort A 104, historical data for Cohort B 106, and historical data for Cohort C 108 are then input to one or more machine learning (ML) models implemented using the machine learning (ML) engine 110. In this specification, the term “engine” is used broadly to refer to a software-based system or subsystem that can perform one or more specific functions—in this case, training and running one or more ML models. In general, ML engines (e.g., ML engine 110 in FIG. 1, ML engine 210 in FIG. 2, ML engine 310 in FIG. 3) can be implemented as one or more software modules or components, installed on one or more computers in one or more locations. In some cases, one or more computers will be dedicated to a particular engine; in other cases, multiple engines can be installed and running on the same computer or computers.

As used throughout this specification, the term “machine learning models” can include models that employ decision trees, linear regression, neural networks, multinomial logistic regression, Naive Bayes (NB), trained Gaussian NB, NB with dynamic time warping, multiple linear regression, Shannon entropy, support vector machine (SVM), one versus one support vector machine, k-means clustering, Q-learning, temporal difference (TD), neural networks, deep adversarial networks, and/or the like. In some implementations, the machine learning models can be trained using supervised learning or reinforcement learning approaches. In some cases, the machine learning models can be implemented using an active learning approach such that observed outcomes are compared to their predicted outcomes and fed back to the machine learning models to further train the machine learning models. Through this process, the machine learning models can continually improve in performance by collecting additional training data from subsequent instances in which the machine learning models are used.

The one or more machine learning models of the ML engine 110 are trained (e.g., using other examples of historical cohort data and subsequent payment, cost, and churn information for those cohorts) to receive the historical data 104, 106, 108 as inputs and to process the inputs to produce predictions of aggregate payments, aggregate costs, and aggregate churn associated with each corresponding cohort. For example, in one proposed architecture, the ML engine 110 can include three machine learning systems-one machine learning system trained to make predictions for cohorts similar to Cohort A (Cohort A predictions 112A), another machine learning system trained to make predictions for cohorts similar to Cohort B (Cohort B predictions 112B), and a third machine learning system trained to make predictions for cohorts similar to Cohort C (Cohort C predictions 112C). Each of these machine learning systems can, in turn, include three separate machine learning models-one machine learning model that makes predictions of aggregate payments for the relevant cohort (e.g., aggregate payments 114A, 114B, 114C), one machine learning model that makes predictions of aggregate costs for the relevant cohort (e.g., aggregate costs 116A, 116B, 116C), and one machine learning model that makes predictions of aggregate churn for the relevant cohort (e.g., aggregate payments 118A, 118B, 118C). However, this is only an example, and a variety of other architectures can be implemented to achieve similar predictions.

The aggregate payments 114A, 114B, 114C represent, for one or more subscribers in each cohort, a predicted number of future payments that the one or more subscribers in the cohort will make to the network provider. The aggregate costs 116A, 116B, 116C represent, for one or more subscribers in each cohort, a predicted amount of future costs that the network provider will incur in providing services to the one or more subscribers in the cohort. The aggregate churn 118A, 118B, 118C represent, for one or more subscribers in each cohort, a predicted level of churn for the one or more subscribers in the cohort.

For each cohort, a customer lifetime value (CLV) 120 can be estimated based on the predictions of aggregate payments, aggregate costs, and aggregate churn outputted by the ML Engine 110. For example, the predictions of aggregate payments 114A, aggregate costs 116A, and aggregate churn 118A can be combined to estimate a CLV 120 for Cohort A. The predictions of aggregate payments 114B, aggregate costs 116B, and aggregate churn 118B can be combined to estimate a CLV 120 for Cohort B. And the predictions of aggregate payments 114C, aggregate costs 116C, and aggregate churn 118C can be combined to estimate a CLV 120 for Cohort C. As a specific example, one method of estimating CLV includes computing the difference between the predictions of aggregate payments and aggregate costs, and then dividing the difference by a prediction of aggregate churn. However, CLV can be implemented in other ways as well. In general, CLV can be any metric that combines predictions of aggregate payments, aggregate costs, and aggregate churn to compute a value indicative of a future profitability (e.g., to a network provider) associated with one or more customers (e.g., subscribers to the network provider's cellular network).

### Value at Risk

Referring now to the process 200 shown in FIG. 2, CLV can be built upon to determine the value at risk associated with the potential loss of a particular wireless subscriber. While CLV (e.g., CLV 120) is estimated at the cohort level and is thus representative of the wireless subscribers belonging to the relevant cohort, the estimation of CLV typically does not consider certain types of personal events experienced by wireless subscribers such as dropped calls, bandwidth throttling (e.g., in response to exceeding a data quota), customer support experiences, missing payments in the past few billing cycles, etc. However, these events can have substantial influence on a wireless subscriber's decision to churn. Thus, it can be desirable to have a separate model (referred to as a “line churn model”) that considers these events and outputs a predicted probability of churn for an individual line.

The ML Engine 210 includes one or more machine learning models that performs this task. Trained on historical data from multiple subscribers, including data about personal events (e.g., dropped calls, bandwidth throttling events, customer support experiences, missing payments, etc.) and line churn outcomes, the one or more machine learning models of the ML Engine 210 receives individual subscriber data 202 and outputs a predicted probability of churn for an individual line 220 associated with the wireless subscriber. As shown in FIG. 2, the individual subscriber data 202 can include information about payments, data usage, costs, churn events, devices, plan features, longevity, region, demographic features, dropped calls, bandwidth throttling events, customer support experiences, missing payments, and more.

At the next stage in the process 200, the CLV 120 for the wireless subscriber (e.g., the CLV for a cohort that includes the wireless subscriber) is combined with the predicted probability of churn for the individual line 220 to determine a value at risk 230 for the individual wireless subscriber. As a specific example, the value at risk 230 can be calculated by multiplying the CLV 120 by the predicted probability of churn for the individual line 220. However, other calculations of a metric for the value at risk 230 can be implemented. What is important is that (i) the value at risk 230 increases as the CLV 120 increases (since there are more profits at stake for high-value customers) and that (ii) the value at risk 230 increases as the probability of churn for the individual line 220 increases (since, in expectation, a greater proportion of the CLV is at risk of being lost).

### Allocation of Additional Data Usage Quotas

FIG. 3 shows a process 300 that builds upon determinations of CLV and value at risk to make decisions about whether or not to apply a treatment (e.g., the allocation of an additional data quota, referred to herein as a “data gift”) to a particular wireless subscriber. In order to do so, the process 300 not only considers the value at risk 230 associated with the particular wireless subscriber, but also (i) an estimate of how much additional data the subscriber will likely need (e.g., predicted data need for individual line 308), (ii) information about an amount of data available to allocate (e.g., available data pool 306), and (iii) an estimated likelihood that an allocation of an additional data quota of a certain size will satisfy the customer (e.g., leading to a reduced likelihood of chum).

To determine the estimate of how much additional data the wireless subscriber will likely need (e.g., in the next 3 months, in the next 12 months, in the next 24 months, in the next 48 months, through the end of a data plan period, through the end of a payment period, etc.), the process 300 includes use of a ML engine 310 that includes one or more machine learning models trained to output, for a particular wireless subscriber, the predicted data need for an individual line 308 associated with the wireless subscriber. The one or more machine learning models are trained using historical data for multiple subscribers 302 including information about payments, data usage, costs to the network provider, chum events, device types, plan features, subscriber longevity, location, demographic features, etc. The one or more machine learning models included in the ML engine 310 are also trained using information about historical data usage for the individual line 304 (e.g., to recognize patterns in the data usage of the particular wireless subscriber). Based on this training data, the ML engine 310 is trained to forecast, at any time and for any wireless subscriber, the wireless subscriber's need for additional data (e.g., an amount of data usage by which the individual is predicted to exceed his/her data plan limit).

To determine a potential treatment 312 for the wireless subscriber (e.g., an allocation of a data gift to the wireless subscriber to prevent the wireless subscriber from churning), the predicted data need for the individual line 308 is considered along with the value at risk 230 for the corresponding wireless subscriber and the available data pool 306 (e.g., a total amount of data available to be allocated to users of a network while respecting bandwidth limitations of the network). For example, in some cases, only a certain amount of data is available to be allocated across all subscribers. In such cases, the size of data gifts can be scaled according to the size of the available data pool 306. In addition, the allocation of the data gifts can be targeted towards subscribers who will likely need the additional data (e.g., as determined by predicted data need for the individual line 308) and/or subscribers who represent the largest value at risk 230. This approach to allocating data gifts can result in more efficient allocation of the available data pool 306 to improve profitability for the network provider, e.g., by preventing the churn of high-value customers.

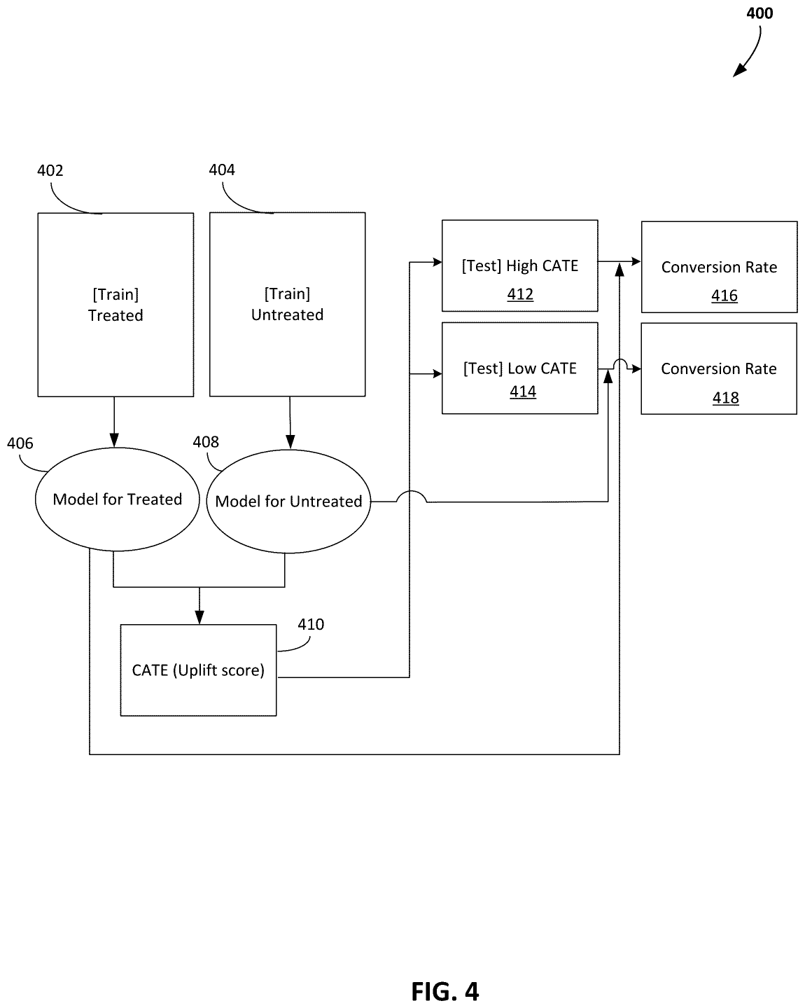

Once a potential treatment 312 is identified for a wireless subscriber, the process 300 can include determining whether or not an estimated effect of the treatment is satisfactory. In some implementations, the treatment effect for a potential treatment 312 can be estimated based on an A/B testing process and/or an uplift modeling process, as described in further detail below in relation to FIG. 4. In some implementations, the treatment effect can be deemed satisfactory if it prevents the subscriber from churning, and the treatment effect can be deemed unsatisfactory if it fails to prevent the subscriber from churning. In other implementations, the treatment effect can be deemed satisfactory or unsatisfactory based on a metric indicative of a value at risk that is prevented from being lost. For example, even if the churn of a customer is able to be prevented by allocating the customer a certain amount of additional data usage, the treatment effect may still be considered unsatisfactory if the customer is a low-value customer. This is because the same additional data usage quota might be more efficiently allocated to a higher-value customer to prevent a larger value at risk from being lost.

Upon determining, at step 314, that the estimated treatment effect is satisfactory, the process 300 includes applying the treatment (316). For example, applying the treatment (316) can involve allocating an additional data usage quota to a wireless subscriber. Alternatively, if at step 314, it is determined that the estimated treatment effect is unsatisfactory, the process 300 can include determining a new potential treatment 312 for the wireless subscriber of interest (e.g., based on the predicted data need for the individual line 308, the value at risk 230, and the available data pool 306). The new potential treatment 312 can then be assessed for its estimated treatment effect, including determining if the estimated treatment effect is satisfactory (at step 314). The process 300 can conclude once one or more treatments have been applied, once a set of potential treatments have been exhausted, and/or once there is less than a threshold amount of data remaining in the available data pool 306.

Referring now to FIG. 4, a process 400 is described for estimating a likely treatment effect of applying a treatment (e.g., the allocation of an additional data usage quota) to a particular wireless subscriber. The process 400 can be based on an initial A/B testing process to collect experimental data and/or an uplift modeling process. In general, A/B testing (also called “split testing”) refers to a randomized experimentation process wherein two or more versions of a variable (e.g., a web page, a page element, a treatment such as a data gift, etc.) are presented to different segments of a population at the same time to determine which version leaves the maximum impact and drives business metrics. Uplift modeling refers to techniques (including machine learning approaches) to estimate and predict individual-level or subgroup-level causal effects of different treatments in an experiment. Principles of A/B testing and uplift modeling can be applied, in the current context, to estimate the treatment effects that allocating data gifts to wireless subscribers is likely to have on certain kinds of wireless subscribers (e.g., wireless subscribers sharing one or more characteristics such as demographic features, device types, data usage, etc.). For example, the process 400 might be performed by a network provider seeking to optimize the allocation of data gifts to the provider's wireless subscribers in order to maximize profitability. Examples of uplift modeling approaches are discussed in Zhenyu Zhao and Totte Harinen (2020, Mar. 26). Uplift Modeling for Multiple Treatments with Cost Optimization. arXiv: 1908.05372v3, which is incorporated by reference herein, in its entirety.

In one implementation, the process 400 includes creating a training set and test set of wireless subscribers. For example, a network provider can use a randomized process to assign wireless subscribers to the training set or to the testing set. In some cases, the assignment of wireless subscribers to the training set or the testing set can include use of a stratification to ensure that the training set is representative of the testing set. The training set can then be divided (e.g., using a random selection process) to a group of treated subscribers 402 and a group of untreated subscribers 404 (also referred to as a “control group”). For example, implementing well-known principles of A/B testing, each individual in the randomly selected group of treated subscribers 402 can be provided with a data gift, while the individuals in the randomly selected group of untreated subscribers 404 are not give provided with a data gift. Then, after a certain duration of time (e.g., 1 month, 3 months, 12 months, 24 months, 48 months, etc.), differences in various metrics between the treated subscribers 402 and the untreated subscribers 404 can be measured and compared (e.g., metrics indicative of churn rates, subsequent payments made to the network provider, etc.).

Based on the metrics measured for the group of treated subscribers 402, a model for treated subscribers 406 can be developed. For example, the model 406 can be a machine learning model trained to output an estimated treatment effect (e.g., decreased churn rate, increased payments made to the network provider, etc.) based on one or more characteristics of the group of treated subscribers (e.g., demographic features, device type, longevity, data plan type, data usage, predicted data need, etc.). The estimated treatment effect can be expressed as a conversion rate 416 (e.g., a percentage of wireless subscribers that achieve a desired a goal such as churn prevention and/or continued payments to the network provider).

Similarly, based on the metrics measured for the group of untreated subscribers 404, a model for untreated subscribers 408 can be developed. For example, the model 408 can be a machine learning model trained to output an estimated outcome (e.g., churn rate, payments made to the network provider, etc.) based on one or more characteristics of the group of untreated subscribers (e.g., demographic features, device type, longevity, data plan type, data usage, predicted data need, etc.). The estimated outcomes can be expressed as a conversion rate 418 (e.g., a percentage of wireless subscribers that achieve a desired a goal such as churn prevention and/or continued payments to the network provider).

Using principles of uplift modeling, the process 400 can include determining a conditional average treatment effect (CATE) 410, or “uplift score,” based on the model for treated subscribers 406 and the model for untreated subscribers 408. The CATE represents the expected difference in outcomes for a treated individual and an untreated individual that both share a particular set of characteristics (e.g., demographic features, device type, longevity, data plan type, data usage, predicted data need, etc.). The CATE is of special interest in this context because it allows one to understand how treatment effects (e.g., the response to being allocated a data gift) vary depending on observed characteristics of the network provider's subscribers. This understanding can, in turn, lead to targeting treatments more effectively among the network provider's wireless subscribers.

To assess the efficacy of the CATE 410, the process 400 can include performing one or more analyses on the test set of wireless subscribers. For example, a CATE can be estimated for each individual in the test set of wireless subscribers, and the test set of wireless subscribers can then be divided, based on the CATE scores, into a “High CATE” group 412 and a “Low CATE” group 414. For example, all wireless subscribers in the test set having an estimated CATE above a first threshold can be assigned to the High CATE group 412, and all wireless subscribers in the test set having an estimated CATE below a second threshold can be assigned to the Low CATE group 414. An actual conversion rate 416 (e.g., a percentage of wireless subscribers that achieve a desired a goal such as churn prevention and/or continued payments to the network provider) can then be determined for the High CATE group 412, and similarly, an actual conversion rate 418 can be determined for the Low CATE group 414. In this example, substantial differences between the conversion rates 416 and 418 can be indicative of a CATE 410 that is particularly useful for targeting treatments (e.g., data gifts) to wireless subscribers most likely to respond desirably to the treatment. Alternatively, if no substantial difference is observed between the conversion rates 416 and 418, this can be an indication that further work is needed to develop the model for treated subscribers 406, the model for untreated subscribers 408, and/or the determination of the CATE 410. As described above, an effective CATE 410 can be implemented in the process 300 to estimate a treatment effect and determine, at step 314, if the estimated treatment effect is satisfactory.

### Selecting Candidate Locations for Wireless Network Infrastructure or a Retail Location

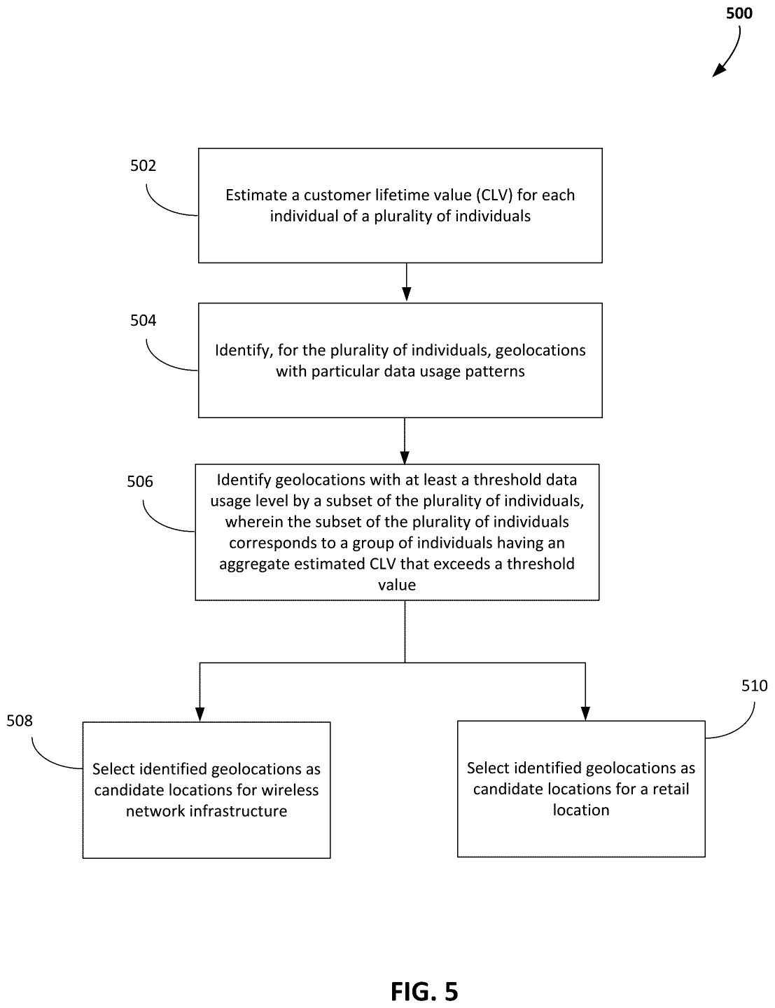

FIG. 5 shows an example process 500 for selecting candidate locations for wireless network infrastructure or a retail location (e.g., a wireless retail location where data plans are sold). The process 500 includes estimating a customer lifetime value (CLV) for each individual of a plurality of individuals (502). For example, the CLV can correspond to the CLV 120 described in relation to FIG. 1 and can be estimated according to the process 100, as described above. The individuals, in some implementations, can be a set of wireless subscribers, e.g., subscribers to a network provider's network.

The process 500 also includes identifying, for the plurality of individuals, geolocations with particular data usage patterns (504). For example, by analyzing information about the data usage of various wireless subscribers, it can be determined that certain geolocations receive more or less usage during certain times of the day—in some cases by wireless subscribers having a distinctive set of characteristics. Based on these analyses, certain geolocations can be identified as high data usage geolocations, low data usage geolocations, geolocations that correspond to residential usage (e.g., a home location for many wireless subscribers), geolocations the correspond to enterprise usage (e.g., a work location for many wireless subscribers), etc.

The process 500 also includes identifying geolocations (and nearby areas surrounding the geolocation) with at least a threshold data usage level by a subset of the plurality of individuals, wherein the subset of the plurality of individuals corresponds to a group of individuals having an aggregate estimated CLV that exceeds a threshold value (506). For example, upon identifying (at step 504) that a geolocation has a level of data usage by a subset of wireless subscribers that exceeds a certain threshold usage level, further analysis of the wireless subscribers can be implemented to determine the relative profitability or “value” of the geolocation to the network provider. The analysis of the wireless subscribers can include identifying which wireless subscribers contribute to the overall data usage at the geolocation, and then using their corresponding CLV scores as an indication of the overall value of the geolocation. In some implementations, a geolocation can be identified as a relatively high-value geolocation if the sum of the CLV scores for all (or a substantial portion of) wireless subscribers who contribute to data usage at the geolocation exceeds a threshold value. The sum (or other aggregate) of the CLV scores for all (or a substantial portion of) wireless subscribers who contribute to data usage at the geolocation can be indicative of an “estimated lifetime value” for the geolocation (e.g., since it is indicative of the long-term profitability of the geolocation to the network provider). In some implementations, a geolocation can be identified as a relatively high-value geolocation if the number of wireless subscribers that have a CLV score above a threshold value exceeds a certain number. In some implementations, multiple geolocations can be ranked relative to one another based on the CLVs for all (or a substantial portion of) wireless subscribers who contribute to data usage at each of the geolocations, and a certain number of the highest ranked geolocations can be identified as relatively high-value geolocations.

In some implementations, the process 500 includes selecting identified geolocations (e.g., geolocations identified as being relatively high-value geolocations) as candidate locations for wireless network infrastructure (508). For example, the geolocations identified at step 506 of the process 500 can be selected as candidate locations for building or installing wireless network infrastructure such as a cellular tower. This can improve the efficiency of utilizing the network provider's resources by improving network performance and/or capacity in areas where there is the most data usage by high-value customers.

In some implementations the process 500 includes selecting identified geolocations (e.g., geolocations identified as being relatively high-value geolocations) as candidate locations for a retail location (510). For example, the geolocations identified at step 506 of the process 500 can be selected as candidate locations for building or establishing a wireless retail location where data plans are sold. This can improve the efficiency of utilizing the network provider's resources by (i) improving customer service in areas where there is the most data usage by high-value customers and (ii) expanding opportunities to sell additional data plans to other high-value customers in (or near) areas where there is the most data usage by high-value customers. In some implementations, an identified geolocation is only selected as a candidate location for building or establishing a wireless retail location if a service coverage provided by the wireless provider at the identified geolocation exceeds a threshold coverage level. This is because a network provider might not wish to sell data plans to individuals in a location where the network provider's network does not provide at least a minimal level of service coverage.

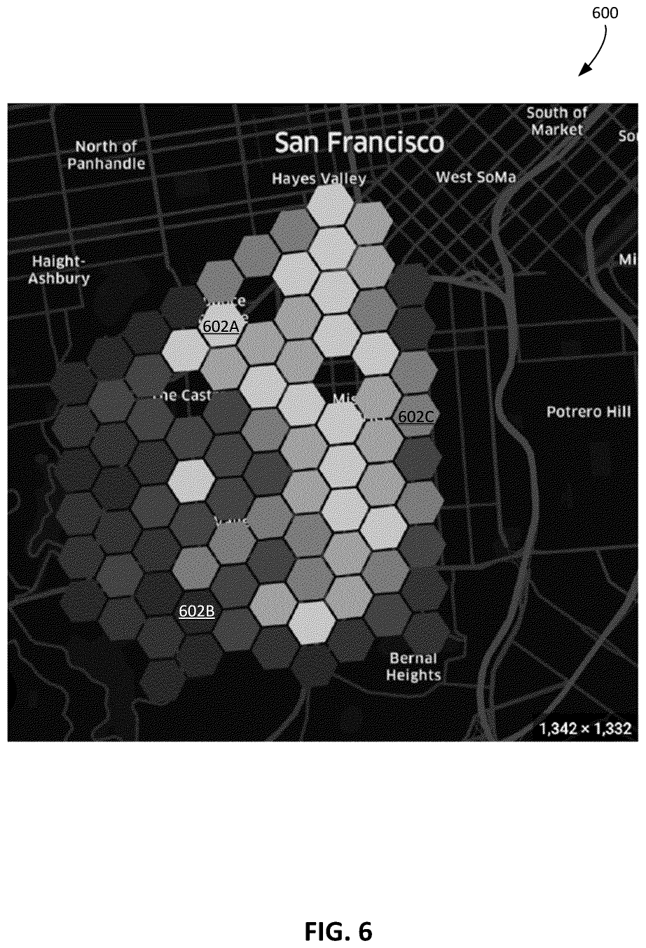

FIG. 6 shows a visualization 600 of a metric indicative of the estimated lifetime value of various geolocations. In the visualization 600, geolocations are each depicted with corresponding hexagonal cells (e.g., cells 602A-602C), sometimes referred to herein as a “micro-neighborhoods.” The shading of the cells 602A-602C represents a metric indicative of the estimated lifetime value for each of the cell's respective geolocations. Lighter cells (e.g., cell 602A) represent geolocations with lower estimated lifetime values, while darker cells (e.g., cell 602B) represent geolocations with higher estimated lifetime values. As described previously, estimated lifetime values for each geolocation can be represented using a metric that aggregates the CLV scores for all (or a substantial portion of) wireless subscribers who contribute to data usage at the geolocation. Thus, in the visualization 600, darker cells (as opposed to lighter cells) can represent preferred candidate locations for installing wireless network infrastructure and/or establishing a retail location. In some implementations, to mitigate sharp discontinuities between estimated lifetime values of adjacent geolocations, the estimated lifetime values for a particular geolocation can be averaged with corresponding estimated lifetime values for nearby geolocations (e.g., adjacent geolocations), for example, by performing a weighted average (e.g., with higher weights assigned to the values associated with closer geolocations).

While FIGS. 5 and 6 illustrate how candidate locations for wireless network infrastructure or retail locations can be selected from among geolocations where wireless subscriber data already exists, in some cases, a network provider may wish to consider installing wireless network infrastructure or establishing a retail location in a site where wireless subscriber data (or at least, a threshold amount of such data) is not available. For example, the network provider may be interested in expanding the current coverage of its network to new areas and/or selling data plans to users in a new regional market.

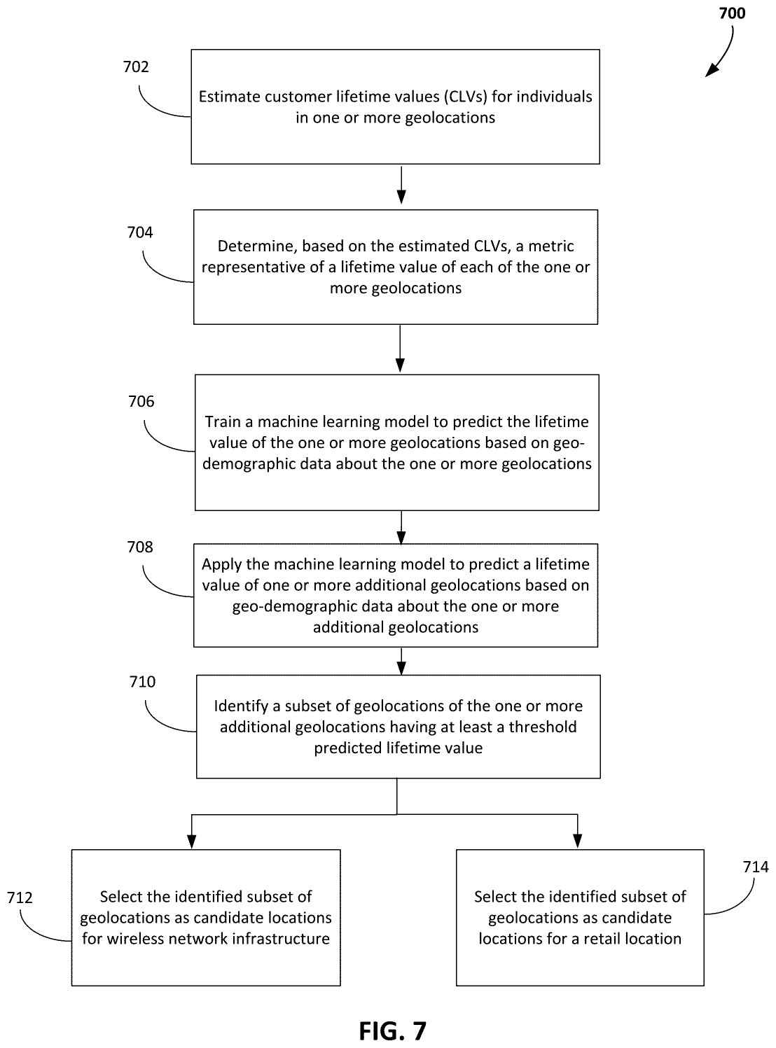

FIG. 7 shows an example process 700 for selecting candidate locations for wireless network infrastructure or a retail location, even when wireless subscriber data (or at least, a threshold amount of such data) is not available for the candidate locations. The process 700 includes estimating customer lifetime values (CLVs) for individuals in one or more geolocations (702). For example, the CLVs can correspond to the CLV 120 described in relation to FIG. 1 and can be estimated according to the process 100, as described above. The individuals, in some implementations, can be a set of wireless subscribers, e.g., subscribers to a network provider's network. The one or more geolocations can correspond to one or more geolocations within the network provider's coverage area where wireless subscriber data is available.

The process 700 also includes determining, based on the estimated CLVs, a metric representative of a lifetime value of each of the one or more geolocations (704). For example, the metric representative of the lifetime value of each of the one or more geolocations can correspond to the aggregate CLV metrics disclosed in relation to FIG. 5.

The process 700 also includes training a machine learning model to predict the lifetime value of the one or more geolocations based on geo-demographic data about the one or more geolocations (706). For example, the aggregate CLV metrics for the one or more geolocations can be used as training data, along with geo-demographic data about the one or more geolocations (e.g., an age distribution of residents in each geolocation, average property value for each geolocation, type of occupation of residents in each geolocation, population size for each geolocation, etc.) to train a machine learning model that predicts the aggregate CLV metric for a geolocation based on geo-demographic data about the geolocation. In other words, using geolocations where wireless subscriber data is available to directly calculate a lifetime value for the geolocations (e.g., serving as a “ground truth” approach), a machine learning model is trained to indirectly estimate the lifetime values for geolocations based on geo-demographic data—an approach that can be implemented even when wireless subscriber data is not available. Thus, using this trained machine learning model, estimated lifetime values for one or more additional geolocations can be predicted regardless of whether or not wireless subscriber data for these geolocations is available. This indirect approach to predicting lifetime values for geolocations can be advantageous since oftentimes geo-demographic data about geolocations may be accessible even when wireless subscriber data is not (e.g., when a network provider has not yet expanded its coverage area to service the geolocation of interest). Accordingly, the process 700 includes applying the machine learning model to predict a lifetime value of one or more additional geolocations based on geo-demographic data about the or more additional geolocations (708). These one or more additional geolocations can correspond to sites where a network provider is considering the installation of wireless network infrastructure or the establishment of a retail location.

The process 700 also includes identifying a subset of geolocations of the one or more additional geolocations having at least a threshold predicted lifetime value (710). For example, after applying the machine learning model to predict the lifetime value of the one or more additional geolocations, the geolocations can be ranked based on estimated lifetime value and only a certain number of the highest ranked geolocations can make up the identified subset. In some implementations, any geolocation having a predicted lifetime value that exceeds a threshold value is included in the identified subset. In some cases, the threshold value can be selected based on a profitability level that the network provider intends to achieve with the installation of the wireless network infrastructure and/or the establishment of a retail location.

In some implementations, the process 700 includes selecting the identified subset of geolocations (e.g., the subset of geolocations identified at step 710) as candidate locations for wireless network infrastructure (712). For example, the subset of geolocations identified at step 710 of the process 700 can be selected as candidate locations for building or installing wireless network infrastructure such as a cellular tower. This can improve the efficiency of utilizing the network provider's resources by targeting the installation of new wireless network infrastructure (and the expansion of the network provider's network) toward locations that are expected to contribute the most to the long-term profitability of the network provider.

In some implementations, the process 700 includes selecting the identified subset of geolocations (e.g., the subset of geolocations identified at step 710) as candidate locations for a retail location (714). For example, the subset of geolocations identified at step 710 of the process 700 can be selected as candidate locations for establishing a wireless retail location where data plans are sold. This can improve the efficiency of utilizing the network provider's resources by targeting the establishment of new wireless retail locations toward areas that are likely to contribute the most to the long-term profitability of the network provider (e.g., through the selling of data plans to new high-value customers located in or nearby the retail location). In some implementations, the identified subset of geolocations is only selected as candidate locations for establishing a wireless retail location if a service coverage provided by the wireless provider at the identified geolocation exceeds a threshold coverage level. This is because a network provider might not wish to sell data plans to individuals in a location where the network provider's network does not provide at least a minimal level of service coverage.

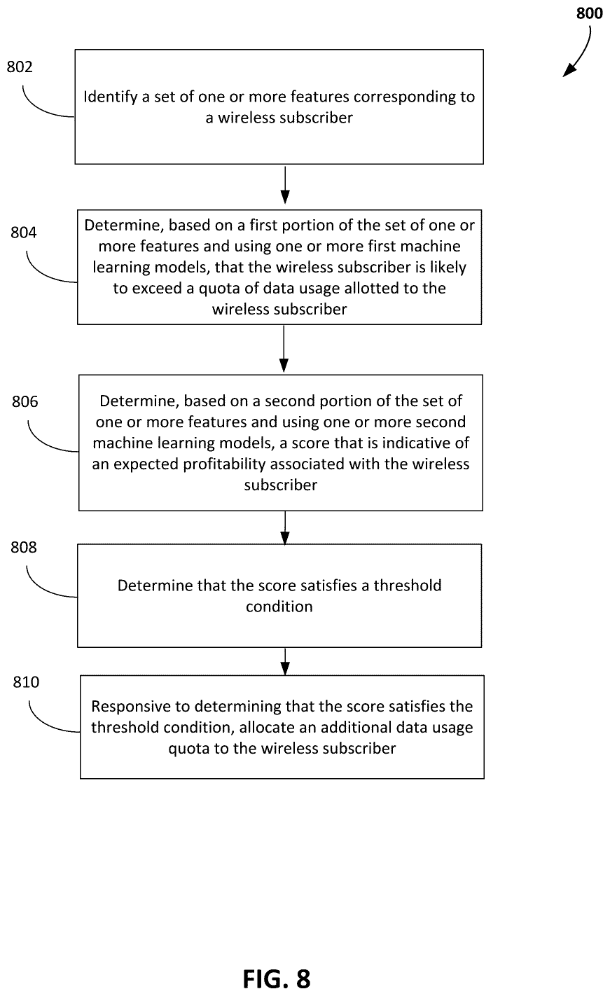

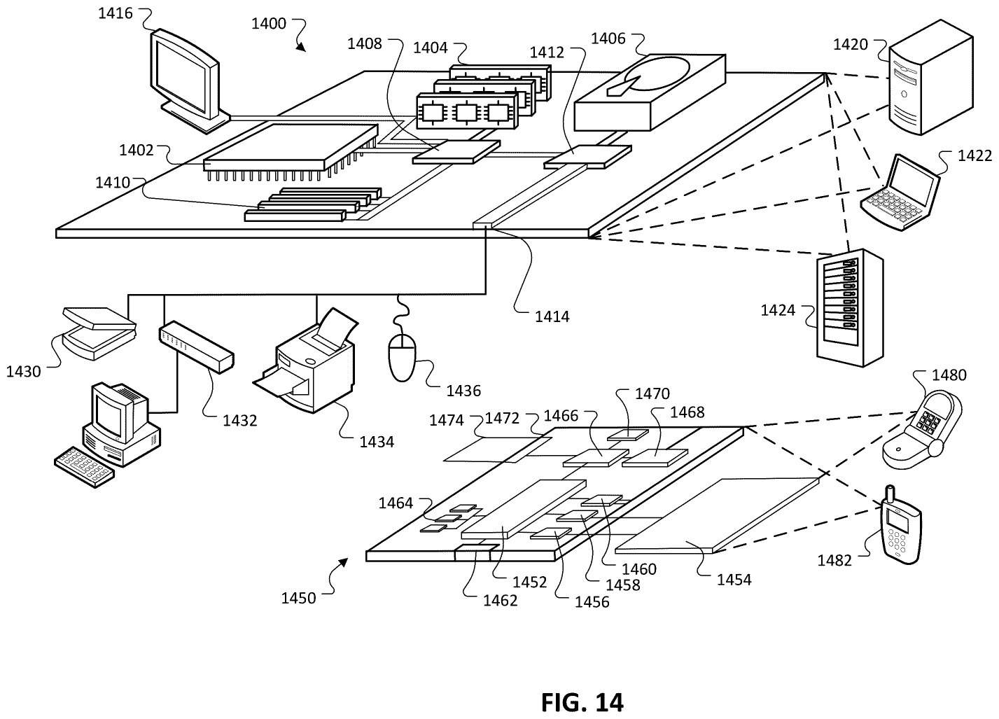

FIG. 8 illustrates an example process 800 for allocating an additional data usage quota to a wireless subscriber. In some implementations, operations of the process 800 can be executed by a computing device or mobile computing device such as those described below in relation to FIG. 14. Operations of the process 800 include identifying a set of one or more features corresponding to a wireless subscriber (802). In some implementations, the set of one or more features can include historical payments made by the wireless subscriber, historical data usage, historical costs associated with providing services to the wireless subscriber, a type of device of the wireless subscriber, a type of data plan associated with the wireless subscriber, a longevity of a business relationship with the wireless subscriber, and/or demographic features of the wireless subscriber.

Operations of the process 800 also include determining, based on a first portion of the set of one or more features and using one or more first machine learning models, that the wireless subscriber is likely to exceed a quota of data usage allotted to the wireless subscriber (804). For example, the one or more first machine learning models can correspond to those implemented by the ML engine 310 described in relation to FIG. 3. In some implementations, the quota of data usage allotted to the wireless subscriber can correspond to a quota of data usage beyond which additional data usage is throttled.

Operations of the process 800 also include determining, based on a second portion of the set of one or more features and using one or more second machine learning models, a score that is indicative of an expected profitability associated with the wireless subscriber (806). For example, the one or more second machine learning models can correspond to those implemented by the ML, engine 110 described in relation to FIG. 1, and the score can correspond to a CLV score (e.g., the CLV 120). In some implementations, determining the score that is indicative of the expected profitability associated with the wireless subscriber can include predicting, based on the second portion of the set of one or more features and using the one or more second machine learning models: (i) at least one future payment from the wireless subscriber, (ii) at least one future cost associated with providing services to the wireless subscriber, and (iii) at least on future churn probability associated with the wireless subscriber. Determining the score that is indicative of the expected profitability associated with the wireless subscriber can also include determining the score based on the at least one predicted future payment, the at least one predicted future cost, and the at least one predicted future churn probability. For example, the at least one predicted future payment, the at least one predicted future cost, and the at least one predicted future churn probability can correspond, respectively, to the aggregate payment predictions 114, the aggregate cost predictions 116, and the aggregate churn predictions 118 described in relation to FIG. 1.

Operations of the process 800 also include determining that the score satisfies a threshold condition (808).

Operations of the process 800 also include, responsive to determining that the score satisfies the threshold condition, allocating an additional data usage quota to the wireless subscriber (810). For example, allocating the additional data usage quota can correspond to the applying treatment step (316) described in relation to FIG. 3 above. In some implementations, allocating the additional data usage quota to the wireless subscriber can include estimating an effect associated with allocating the additional data usage quota to the wireless subscriber, and allocating the additional data usage quota to the wireless subscriber if the estimated effect satisfies a pre-determined condition. Estimating the effect associated with allocating the additional data usage quota to the wireless subscriber can include performing A/B testing. For example, the effects associated with allocating the additional data usage quota can be estimated using the process 400 described in relation to FIG. 4, and the pre-determined condition can correspond to, e.g., a reduction in expected chum probability, an increase in future payments to the network provider, etc. In some implementations, allocating the additional data usage quota to the wireless subscriber can include estimating, for each individual in a group of wireless subscribers including the wireless subscriber, a profitability metric associated with allocating an additional data usage quota to the corresponding individual; and allocating the additional data usage quota to the wireless subscriber and one or more other wireless subscribers from the group of wireless subscribers based upon an aggregate of the profitability metrics corresponding to the wireless subscriber and the one or more other wireless subscribers from the group of wireless subscribers. In some implementations, allocating the additional data usage quota to the wireless subscriber comprises determining a magnitude of the additional data usage quota based upon an amount of data available for allocation (e.g., available data pool 306).

Additional operations of the process 800 can include the following. In some implementations, the process 800 can include classifying the wireless subscriber into one of a plurality of cohorts based on the set of one or more features corresponding to the wireless subscriber, and selecting the one or more second machine learning models for use based on the classification of the wireless subscriber. For example, the plurality of cohorts can correspond to Cohorts A, B, and C described above in relation to FIG. 1. Depending on the set of one or more features corresponding to the wireless subscriber, the wireless subscriber can be classified into one of these cohorts and a corresponding set of machine learning models can be selected for use (e.g., a first set of one or more machine learning models that generate Cohort A predictions 112A, a second set of one or more machine learning models that generate Cohort B predictions 112B, a third set of one or more machine learning models that generate Cohort C predictions 112C, etc.).

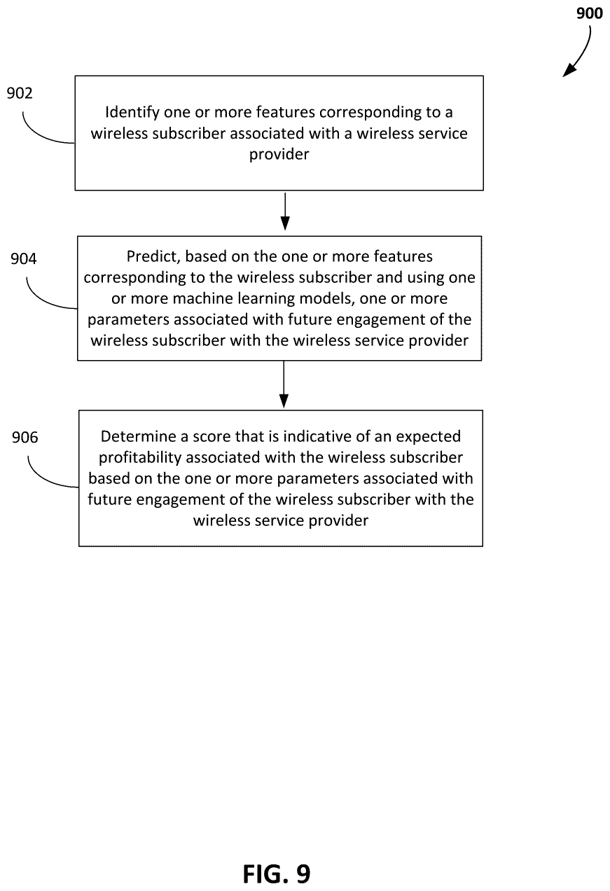

FIG. 9 illustrates an example process 900 for determining a score that is indicative of an expected profitability associated with a wireless subscriber. In some implementations, operations of the process 900 can be executed by a computing device or mobile computing device such as those described below in relation to FIG. 14. Operations of the process 900 include identifying one or more features corresponding to a wireless subscriber associated with a wireless service provider (902). The one or more features corresponding to the wireless subscriber can include historical payments made by the wireless subscriber, historical data usage, historical costs associated with providing services to the wireless subscriber, a type of device of the wireless subscriber, a type of data plan associated with the wireless subscriber, a longevity of a business relationship with the wireless subscriber, and/or demographic features of the wireless subscriber.

Operations of the process 900 also include predicting, based on the one or more features corresponding to the wireless subscriber and using one or more machine learning models, one or more parameters associated with future engagement of the wireless subscriber with the wireless service provider (904). For example, the one or more machine learning models can correspond to those implemented by the ML engine 110 described above in relation to FIG. 1. The one or more parameters associated with future engagement of the wireless subscriber with the wireless service provider can include (i) at least one future payment from the wireless subscriber, (ii) at least one future cost associated with providing services to the wireless subscriber, and (iii) at least one future churn probability associated with the wireless subscriber. For example, the at least one future payment, the at least one future cost, and the at least one future churn probability can correspond, respectively, to the aggregate payment predictions 114, the aggregate cost predictions 116, and the aggregate churn predictions 118 described in relation to FIG. 1. In some implementations, the one or more parameters associated with future engagement of the wireless subscriber with the wireless service provider can correspond to a length of time between 1 day and 48 months subsequent to the predicting. In some implementations, the one or more machine learning models are trained using data about other wireless subscribers, wherein the data includes historical payments made by the other wireless subscribers, historical data usage, historical costs associated with providing services to the other wireless subscribers, churn rates of the other wireless subscribers a type of device of the other wireless subscribers, a type of data plan associated with the other wireless subscribers, a longevity of a business relationship with the other wireless subscribers, and/or demographic features of the other wireless subscribers. In particular, the one or more machine learning models can be trained by splitting the data about the other wireless subscribers into cohort-specific data subsets (e.g., historical data for Cohort A 104, historical data for Cohort B 106, historical data for Cohort C 108) based on a cohort classification associated with each individual of the other wireless subscribers, and then training the one or more machine learning models using one of the cohort-specific data subsets.

Operations of the process 900 also include determining a score that is indicative of an expected profitability associated with the wireless subscriber based on the one or more parameters associated with future engagement of the wireless subscriber with the wireless service provider (906). For example, the score can correspond to a CLV score such as the CLV 120 described above in relation to FIG. 1. In some implementations, the score that is indicative of the expected profitability associated with the wireless subscriber can correspond to a length of time between 1 day and 48 months subsequent to determining the score.

Additional operations of the process 900 can include the following. In some implementations, the process 900 can include classifying the wireless subscriber into one of a plurality of cohorts based on the one or more features corresponding to the wireless subscriber, and selecting the one or more machine learning models for use based on the classification of the wireless subscriber. For example, the plurality of cohorts can correspond to Cohorts A, B, and C described above in relation to FIG. 1. Depending on the set of one or more features corresponding to the wireless subscriber, the wireless subscriber can be classified into one of these cohorts and a corresponding set of machine learning models can be selected for use (e.g., a first set of one or more machine learning models that generate Cohort A predictions 112A, a second set of one or more machine learning models that generate Cohort B predictions 112B, a third set of one or more machine learning models that generate Cohort C predictions 112C, etc.).

In some implementations, the process 900 can include determining a value at risk associated with the wireless subscriber (e.g., value at risk 230), wherein determining the value at risk is based on the determined score and a predicted line churn probability associated with the wireless subscriber (e.g., predicted probability of churn for individual line 220). The predicted line churn probability can be output by an additional machine learning model that is distinct from the one or more machine learning models. For example, the additional machine learning model can correspond to a machine learning model implemented by the ML engine 210 described in relation to FIG. 2.

In some implementations, the process 900 can include determining that the score satisfies a threshold condition, and responsive to determining that the score satisfies the threshold condition, performing one or more actions to decrease a probability that the wireless subscriber chums. For example, the one or more actions can include allocating the wireless subscriber a data gift, as described in relation to FIGS. 3 and 4 above.

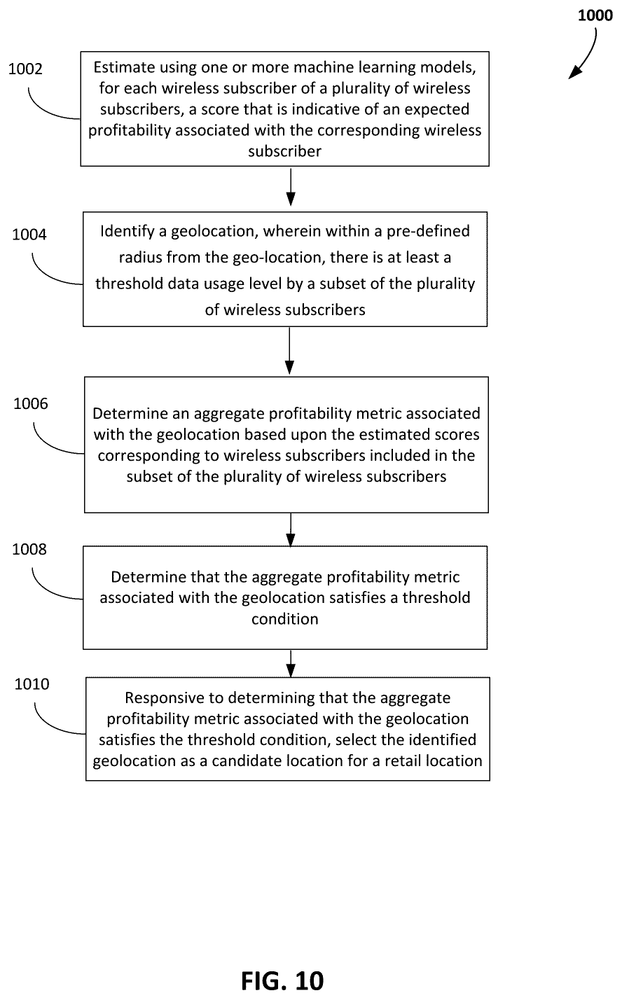

FIG. 10 illustrates an example process 1000 for selecting a geolocation as a candidate location for a retail location. In some implementations, operations of the process 1000 can be executed by a computing device or mobile computing device such as those described below in relation to FIG. 14. Operations of the process 1000 include estimating using one or more machine learning models, for each wireless subscriber of a plurality of wireless subscribers, a score that is indicative of an expected profitability associated with the corresponding wireless subscriber (1002). For example, the score can correspond to CLV scores such as the CLV 120 described in relation to FIG. 1, and the one or more machine learning models can correspond to those implemented by the ML engine 110. In some implementations, estimating the score that is indicative of an expected profitability associated with the corresponding wireless subscriber can include predicting, based on one or more features corresponding to the wireless subscriber, (i) at least one future payment from the wireless subscriber, (ii) at least one future cost associated with providing services to the wireless subscriber, and (iii) at least one future churn probability associated with the wireless subscriber. Estimating the score that is indicative of an expected profitability associated with the corresponding wireless subscriber can also include determining the score based on the at least one predicted future payment, the at least one predicted future cost, and the at least one predicted future churn probability. For example, the at least one future payment, the at least one future cost, and the at least one future churn probability can correspond, respectively, to the aggregate payment predictions 114, the aggregate cost predictions 116, and the aggregate churn predictions 118 described in relation to FIG. 1. In some implementations, the one or more features corresponding to the wireless subscriber can include historical payments made by the wireless subscriber, historical data usage, historical costs associated with providing services to the wireless subscriber, a type of device of the wireless subscriber, a type of data plan associated with the wireless subscriber, a longevity of a business relationship with the wireless subscriber, and/or demographic features of the wireless subscriber.

Operations of the process 1000 also include identifying a geolocation, wherein within a pre-defined radius from the geo-location, there is at least a threshold data usage level by a subset of the plurality of wireless subscribers (1004). Operations of the process 1000 also include determining an aggregate profitability metric associated with the geolocation based upon the estimated scores corresponding to wireless subscribers included in the subset of the plurality of wireless subscribers (1006), and determining that the aggregate profitability metric associated with the geolocation satisfies a threshold condition (1008). In some implementations, the operations 1004, 1006, and 1008 can be similar, in many respects, to step 506 of the process 500 described above in relation to FIG. 5. Moreover, the aggregate profitability metric associated with the geolocation can correspond to the previously described metrics (e.g., aggregated CLVs) that are indicative of the lifetime value of a geolocation, as described above. In some implementations, identifying the geolocation can include identifying the geolocation as a home location or a work location of one or more wireless subscribers included in the subset of the plurality of wireless subscribers based on (i) cellular usage patterns of the one or more wireless subscribers and (ii) data about locations of wireless network infrastructure components.

Operations of the process 1000 also include responsive to determining that the aggregate profitability metric associated with the geolocation satisfies the threshold condition, selecting the identified geolocation as a candidate location for a retail location (1010). For example, the operation 1010 can be similar, in many respects, to the step 510 of the process 500 described above in relation to FIG. 5. In some implementations, selecting the identified geolocation as a candidate location for a retail location can include selecting the identified geolocation only if a service coverage provided by the wireless provider at the identified geolocation exceeds a threshold coverage level.

Additional operations of the process 1000 can include the following. In some implementations, the process 1000 can include collecting demographic data and data usage data associated with the geolocation, and training a machine learning model using the collected demographic data and data usage data to predict aggregate customer lifetime values and/or data usage patterns for additional geolocations based on demographic data about the additional geolocations. For example, the machine learning model can correspond to the machine learning model trained in step 706 of the process 700 described above in relation to FIG. 7.

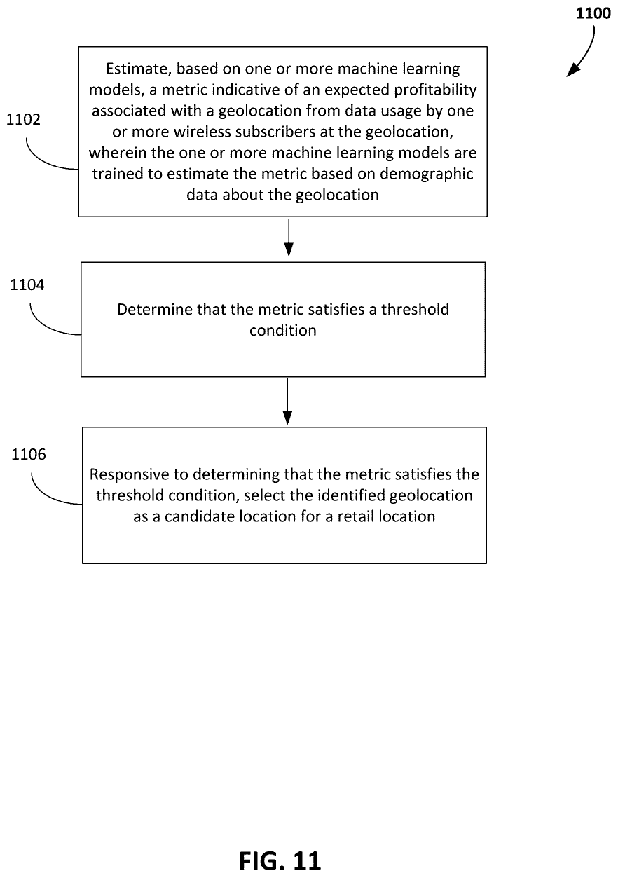

FIG. 11 illustrates another example process 1100 for selecting a geolocation as a candidate location for a retail location. In some implementations, operations of the process 1100 can be executed by a computing device or mobile computing device such as those described below in relation to FIG. 14. Operations of the process 1100 include estimating, based on one or more machine learning models, a metric indicative of an expected profitability associated with a geolocation from data usage by one or more wireless subscribers at the geolocation, wherein the one or more machine learning models are trained to estimate the metric based on demographic data about the geolocation (1102). For example, the one or more machine learning models can correspond to the machine learning model trained in step 706 of the process 700 described above in relation to FIG. 7. In some implementations, the one or more machine learning models can be trained using (i) demographic data and/or data usage patterns for other geolocations and (ii) one or more profitability metrics for the other geolocations. The one or more profitability metrics for the other geolocations can be estimated by aggregating scores for a plurality of individuals using data at each of the other geolocations, wherein the score for each individual (e.g., a CLV for each individual) is indicative of an expected profitability associated with the individual. Determining the score for each individual of the plurality of individuals can include predicting, based on one or more features corresponding to the individual and using one or more additional machine learning models: (i) at least one future payment from the individual, (ii) at least one future cost associated with providing services to the individual, and (iii) at least one future churn probability associated with the individual. Determining the score for each individual of the plurality of individuals can also include determining the score for each individual based on the at least one predicted future payment, the at least one predicted future cost, and the at least one predicted future chum probability. In some implementations, the one or more features corresponding to the individual comprises historical payments made by the individual, historical data usage, historical costs associated with providing services to the individual, a type of device of the individual, a type of data plan associated with the individual, a longevity of a business relationship with the individual, and/or demographic features of the individual.

Operations of the process 1100 also include determining that the metric satisfies a threshold condition (1104), and responsive to determining that the metric satisfies the threshold condition, selecting the identified geolocation as a candidate location for a retail location (1106). For example, the operation 1106 can be similar, in many respects, to the step 714 of the process 700 described above in relation to FIG. 7.

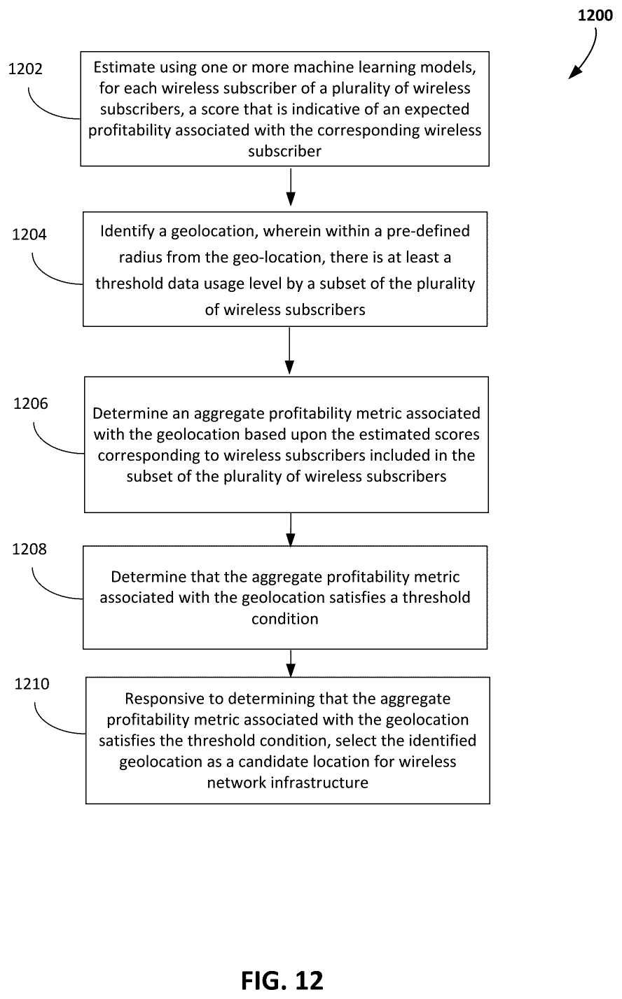

FIG. 12 illustrates an example process 1200 for selecting a geolocation as a candidate location for wireless network infrastructure. In some implementations, operations of the process 1200 can be executed by a computing device or mobile computing device such as those described below in relation to FIG. 14. Operations of the process 1200 include estimating using one or more machine learning models, for each wireless subscriber of a plurality of wireless subscribers, a score that is indicative of an expected profitability associated with the corresponding wireless subscriber (1202). For example, the score can correspond to CLV scores such as the CLV 120 described in relation to FIG. 1, and the one or more machine learning models can correspond to those implemented by the ML, engine 110. In some implementations, estimating the score that is indicative of an expected profitability associated with the corresponding wireless subscriber can include predicting, based on one or more features corresponding to the wireless subscriber, (i) at least one future payment from the wireless subscriber, (ii) at least one future cost associated with providing services to the wireless subscriber, and (iii) at least one future churn probability associated with the wireless subscriber. Estimating the score that is indicative of an expected profitability associated with the corresponding wireless subscriber can also include determining the score based on the at least one predicted future payment, the at least one predicted future cost, and the at least one predicted future churn probability. For example, the at least one future payment, the at least one future cost, and the at least one future churn probability can correspond, respectively, to the aggregate payment predictions 114, the aggregate cost predictions 116, and the aggregate churn predictions 118 described in relation to FIG. 1. In some implementations, the one or more features corresponding to the wireless subscriber can include historical payments made by the wireless subscriber, historical data usage, historical costs associated with providing services to the wireless subscriber, a type of device of the wireless subscriber, a type of data plan associated with the wireless subscriber, a longevity of a business relationship with the wireless subscriber, and/or demographic features of the wireless subscriber.

Operations of the process 1200 also include identifying a geolocation, wherein within a pre-defined radius from the geo-location, there is at least a threshold data usage level by a subset of the plurality of wireless subscribers (1204). Operations of the process 1200 also include determining an aggregate profitability metric associated with the geolocation based upon the estimated scores corresponding to wireless subscribers included in the subset of the plurality of wireless subscribers (1206), and determining that the aggregate profitability metric associated with the geolocation satisfies a threshold condition (1208). In some implementations, the operations 1204, 1206, and 1208 can be similar, in many respects, to step 506 of the process 500 described above in relation to FIG. 5. Moreover, the aggregate profitability metric associated with the geolocation can correspond to the previously described metrics (e.g., aggregated CLVs) that are indicative of the lifetime value of a geolocation, as described above. In some implementations, identifying the geolocation can include identifying the geolocation as a home location or a work location of one or more wireless subscribers included in the subset of the plurality of wireless subscribers based on (i) cellular usage patterns of the one or more wireless subscribers and (ii) data about locations of wireless network infrastructure components.

Operations of the process 1200 also include, responsive to determining that the aggregate profitability metric associated with the geolocation satisfies the threshold condition, selecting the identified geolocation as a candidate location for wireless network infrastructure (1210). For example, the operation 1210 can be similar, in many respects, to the step 508 of the process 500 described above in relation to FIG. 5.

Additional operations of the process 1200 can include the following. In some implementations, the process 1200 can include collecting demographic data and data usage data associated with the geolocation, and training a machine learning model using the collected demographic data and data usage data to predict aggregate customer lifetime values and/or data usage patterns for additional geolocations based on demographic data about the additional geolocations. For example, the machine learning model can correspond to the machine learning model trained in step 706 of the process 700 described above in relation to FIG. 7.

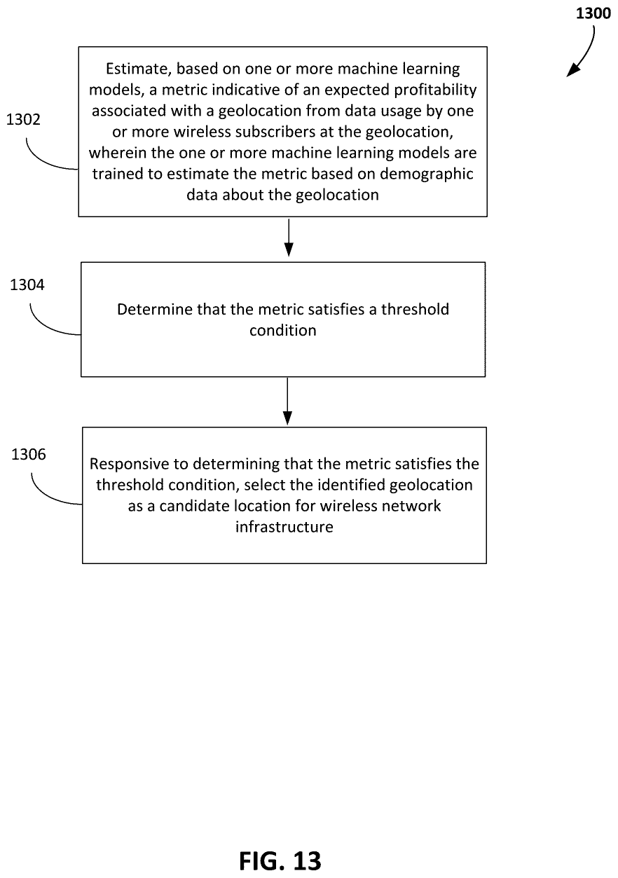

FIG. 13 illustrates another example process 1300 for selecting a geolocation as a candidate location for wireless network infrastructure. In some implementations, operations of the process 1300 can be executed by a computing device or mobile computing device such as those described below in relation to FIG. 14. Operations of the process 1300 include estimating, based on one or more machine learning models, a metric indicative of an expected profitability associated with a geolocation from data usage by one or more wireless subscribers at the geolocation, wherein the one or more machine learning models are trained to estimate the metric based on demographic data about the geolocation (1302). For example, the one or more machine learning models can correspond to the machine learning model trained in step 706 of the process 700 described above in relation to FIG. 7. In some implementations, the one or more machine learning models can be trained using (i) demographic data and/or data usage patterns for other geolocations and (ii) one or more profitability metrics for the other geolocations. The one or more profitability metrics for the other geolocations can be estimated by aggregating scores for a plurality of individuals using data at each of the other geolocations, wherein the score for each individual (e.g., a CLV for each individual) is indicative of an expected profitability associated with the individual. Determining the score for each individual of the plurality of individuals can include predicting, based on one or more features corresponding to the individual and using one or more additional machine learning models: (i) at least one future payment from the individual, (ii) at least one future cost associated with providing services to the individual, and (iii) at least one future churn probability associated with the individual. Determining the score for each individual of the plurality of individuals can also include determining the score for each individual based on the at least one predicted future payment, the at least one predicted future cost, and the at least one predicted future churn probability. In some implementations, the one or more features corresponding to the individual comprises historical payments made by the individual, historical data usage, historical costs associated with providing services to the individual, a type of device of the individual, a type of data plan associated with the individual, a longevity of a business relationship with the individual, and/or demographic features of the individual.

Operations of the process 1300 also include determining that the metric satisfies a threshold condition (1304), and responsive to determining that the metric satisfies the threshold condition, selecting the identified geolocation as a candidate location for wireless network infrastructure (1306). For example, the operation 1306 can be similar, in many respects, to the step 712 of the process 700 described above in relation to FIG. 7.

FIG. 14 shows an example of a computing device 1400 and a mobile computing device 1450 that are employed to execute implementations of the present disclosure. For example, the computing device 1400 and/or the mobile computing device 1450 can be employed to execute one or more of the processes 100, 200, 300, 400, 500, 700, 800, 900, 1000, 1100, 1200, 13000, including one or more portions thereof. In some implementations, multiple computing devices (e.g., multiple computing devices 1400, multiple mobile computing device 1450, or some combination of computing devices 1400 and mobile computing devices 1450)—located either locally or remotely—can be employed to accomplish the same ends. For example, the multiple computing devices and/or mobile computing devices can be connected to one another on the same local network, or via the cloud.

The computing device 1400 is intended to represent various forms of digital computers, such as laptops, desktops, workstations, personal digital assistants, servers, blade servers, mainframes, and other appropriate computers. The mobile computing device 1450 is intended to represent various forms of mobile devices, such as personal digital assistants, cellular telephones, smart-phones, AR devices, and other similar computing devices. The components shown here, their connections and relationships, and their functions, are meant to be examples only, and are not meant to be limiting. In some implementations of the technology disclosed herein, the computing device 1400 and/or the mobile computing device 1450 can correspond to a device embedded or communicably connected to a mass spectrometer (e.g., the mass spectrometer 204) and can cause the mass spectrometer to perform one or more operations.

The computing device 1400 includes a processor 1402, a memory 1404, a storage device 1406, a high-speed interface 1408, and a low-speed interface 1412. In some implementations, the high-speed interface 1408 connects to the memory 1404 and multiple high-speed expansion ports 1410. In some implementations, the low-speed interface 1412 connects to a low-speed expansion port 1414 and the storage device 1404. Each of the processor 1402, the memory 1404, the storage device 1406, the high-speed interface 1408, the high-speed expansion ports 1410, and the low-speed interface 1412, are interconnected using various buses, and may be mounted on a common motherboard or in other manners as appropriate. The processor 1402 can process instructions for execution within the computing device 1400, including instructions stored in the memory 1404 and/or on the storage device 1406 to display graphical information for a graphical user interface (GUI) on an external input/output device, such as a display 1416 coupled to the high-speed interface 1408. In other implementations, multiple processors and/or multiple buses may be used, as appropriate, along with multiple memories and types of memory. In addition, multiple computing devices may be connected, with each device providing portions of the necessary operations (e.g., as a server bank, a group of blade servers, or a multi-processor system).

The memory 1404 stores information within the computing device 1400. In some implementations, the memory 1404 is a volatile memory unit or units. In some implementations, the memory 1404 is a non-volatile memory unit or units. The memory 1404 may also be another form of a computer-readable medium, such as a magnetic or optical disk.

The storage device 1406 is capable of providing mass storage for the computing device 1400. In some implementations, the storage device 1406 may be or include a computer-readable medium, such as a floppy disk device, a hard disk device, an optical disk device, a tape device, a flash memory, or other similar solid-state memory device, or an array of devices, including devices in a storage area network or other configurations. Instructions can be stored in an information carrier. The instructions, when executed by one or more processing devices, such as processor 1402, perform one or more methods, such as those described above. The instructions can also be stored by one or more storage devices, such as computer-readable or machine-readable mediums, such as the memory 1404, the storage device 1406, or memory on the processor 1402.

The high-speed interface 1408 manages bandwidth-intensive operations for the computing device 1400, while the low-speed interface 1412 manages lower bandwidth-intensive operations. Such allocation of functions is an example only. In some implementations, the high-speed interface 1408 is coupled to the memory 1404, the display 1416 (e.g., through a graphics processor or accelerator), and to the high-speed expansion ports 1410, which may accept various expansion cards. In the implementation, the low-speed interface 1412 is coupled to the storage device 1406 and the low-speed expansion port 1414. The low-speed expansion port 1414, which may include various communication ports (e.g., Universal Serial Bus (USB), Bluetooth, Ethernet, wireless Ethernet) may be coupled to one or more input/output devices. Such input/output devices may include a scanner, a printing device, or a keyboard or mouse. The input/output devices may also be coupled to the low-speed expansion port 1414 through a network adapter. Such network input/output devices may include, for example, a switch or router.

The computing device 1400 may be implemented in a number of different forms, as shown in FIG. 14. For example, it may be implemented as a standard server 1420, or multiple times in a group of such servers. In addition, it may be implemented in a personal computer such as a laptop computer 1422. It may also be implemented as part of a rack server system 1424. Alternatively, components from the computing device 1400 may be combined with other components in a mobile device, such as a mobile computing device 1450. Each of such devices may contain one or more of the computing device 1400 and the mobile computing device 1450, and an entire system may be made up of multiple computing devices communicating with each other.

The mobile computing device 1450 includes a processor 1452; a memory 1464; an input/output device, such as a display 1454; a communication interface 1466; and a transceiver 1468; among other components. The mobile computing device 1450 may also be provided with a storage device, such as a micro-drive or other device, to provide additional storage. Each of the processor 1452, the memory 1464, the display 1454, the communication interface 1466, and the transceiver 1468, are interconnected using various buses, and several of the components may be mounted on a common motherboard or in other manners as appropriate. In some implementations, the mobile computing device 1450 may include a camera device(s).

The processor 1452 can execute instructions within the mobile computing device 1450, including instructions stored in the memory 1464. The processor 1452 may be implemented as a chipset of chips that include separate and multiple analog and digital processors. For example, the processor 1452 may be a Complex Instruction Set Computers (CISC) processor, a Reduced Instruction Set Computer (RISC) processor, or a Minimal Instruction Set Computer (MISC) processor. The processor 1452 may provide, for example, for coordination of the other components of the mobile computing device 1450, such as control of user interfaces (UIs), applications run by the mobile computing device 1450, and/or wireless communication by the mobile computing device 1450.

The processor 1452 may communicate with a user through a control interface 1458 and a display interface 1456 coupled to the display 1454. The display 1454 may be, for example, a Thin-Film-Transistor Liquid Crystal Display (TFT) display, an Organic Light Emitting Diode (OLED) display, or other appropriate display technology. The display interface 1456 may include appropriate circuitry for driving the display 1454 to present graphical and other information to a user. The control interface 1458 may receive commands from a user and convert them for submission to the processor 1452. In addition, an external interface 1462 may provide communication with the processor 1452, so as to enable near area communication of the mobile computing device 1450 with other devices. The external interface 1462 may provide, for example, for wired communication in some implementations, or for wireless communication in other implementations, and multiple interfaces may also be used.

The memory 1464 stores information within the mobile computing device 1450. The memory 1464 can be implemented as one or more of a computer-readable medium or media, a volatile memory unit or units, or a non-volatile memory unit or units. An expansion memory 1474 may also be provided and connected to the mobile computing device 1450 through an expansion interface 1472, which may include, for example, a Single in Line Memory Module (SIMM) card interface. The expansion memory 1474 may provide extra storage space for the mobile computing device 1450, or may also store applications or other information for the mobile computing device 1450. Specifically, the expansion memory 1474 may include instructions to carry out or supplement the processes described above, and may include secure information also. Thus, for example, the expansion memory 1474 may be provided as a security module for the mobile computing device 1450, and may be programmed with instructions that permit secure use of the mobile computing device 1450.

In addition, secure applications may be provided via the SIMM cards, along with additional information, such as placing identifying information on the SIMM card in a non-hackable manner.

The memory may include, for example, flash memory and/or non-volatile random access memory (NVRAM), as discussed below. In some implementations, instructions are stored in an information carrier. The instructions, when executed by one or more processing devices, such as processor 1452, perform one or more methods, such as those described above. The instructions can also be stored by one or more storage devices, such as one or more computer-readable or machine-readable mediums, such as the memory 1464, the expansion memory 1474, or memory on the processor 1452. In some implementations, the instructions can be received in a propagated signal, such as, over the transceiver 1468 or the external interface 1462.

The mobile computing device 1450 may communicate wirelessly through the communication interface 1466, which may include digital signal processing circuitry where necessary. The communication interface 1466 may provide for communications under various modes or protocols, such as Global System for Mobile communications (GSM) voice calls, Short Message Service (SMS), Enhanced Messaging Service (EMS), Multimedia Messaging Service (MMS) messaging, code division multiple access (CDMA), time division multiple access (TDMA), Personal Digital Cellular (PDC), Wideband Code Division Multiple Access (WCDMA), CDMA2000, General Packet Radio Service (GPRS). Such communication may occur, for example, through the transceiver 1468 using a radio frequency. In addition, short-range communication, such as using a Bluetooth or Wi-Fi, may occur. In addition, a Global Positioning System (GPS) receiver module 1470 may provide additional navigation- and location-related wireless data to the mobile computing device 1450, which may be used as appropriate by applications running on the mobile computing device 1450.

The mobile computing device 1450 may also communicate audibly using an audio codec 1460, which may receive spoken information from a user and convert it to usable digital information. The audio codec 1460 may likewise generate audible sound for a user, such as through a speaker, e.g., in a handset of the mobile computing device 1450. Such sound may include sound from voice telephone calls, may include recorded sound (e.g., voice messages, music files, etc.) and may also include sound generated by applications operating on the mobile computing device 1450.

The mobile computing device 1450 may be implemented in a number of different forms, as shown in FIG. 14. For example, it may be implemented a phone device 1480, a personal digital assistant 1482, and a tablet device (not shown). The mobile computing device 1450 may also be implemented as a component of a smart-phone, AR device, or other similar mobile device.

Computing device 1400 and/or 1450 can also include USB flash drives. The USB flash drives may store operating systems and other applications. The USB flash drives can include input/output components, such as a wireless transmitter or USB connector that may be inserted into a USB port of another computing device.

Other embodiments and applications not specifically described herein are also within the scope of the following claims. Elements of different implementations described herein may be combined to form other embodiments not specifically set forth above. Elements may be left out of the structures described herein without adversely affecting their operation. Furthermore, various separate elements may be combined into one or more individual elements to perform the functions described herein.

What is claimed is:

1. A method comprising:
identifying one or more features corresponding to a wireless subscriber associated with a wireless service provider;
predicting, based on the one or more features corresponding to the wireless subscriber and using one or more machine learning models, one or more parameters associated with future engagement of the wireless subscriber with the wireless service provider;
determining a score that is indicative of an expected profitability associated with the wireless subscriber based on the one or more parameters associated with future engagement of the wireless subscriber with the wireless service provider;
determining that the score satisfies a threshold condition; and
responsive to determining that the score satisfies the threshold condition, performing one or more actions to decrease a probability that the wireless subscriber churns.

2. The method of claim 1, wherein the one or more parameters associated with future engagement of the wireless subscriber with the wireless service provider comprise:
(i) at least one future payment from the wireless subscriber,
(ii) at least one future cost associated with providing services to the wireless subscriber, and
(iii) at least one future churn probability associated with the wireless subscriber.

3. The method of claim 1, wherein the one or more features corresponding to the wireless subscriber comprise historical payments made by the wireless subscriber, historical data usage, historical costs associated with providing services to the wireless subscriber, a type of device of the wireless subscriber, a type of data plan associated with the wireless subscriber, a longevity of a business relationship with the wireless subscriber, and/or demographic features of the wireless subscriber.

4. The method of claim 1, comprising:
classifying the wireless subscriber into one of a plurality of cohorts based on the one or more features corresponding to the wireless subscriber, and
selecting the one or more machine learning models for use based on the classification of the wireless subscriber.

5. The method of claim 1, wherein the one or more parameters associated with future engagement of the wireless subscriber with the wireless service provider correspond to a length of time between 1 day and 48 months subsequent to the predicting.

6. The method of claim 1, wherein the score that is indicative of the expected profitability associated with the wireless subscriber corresponds to a length of time between 1 day and 48 months subsequent to determining the score.

7. The method of claim 1, wherein the one or more machine learning models are trained using data about other wireless subscribers, wherein the data comprises historical payments made by the other wireless subscribers, historical data usage, historical costs associated with providing services to the other wireless subscribers, churn rates of the other wireless subscribers a type of device of the other wireless subscribers, a type of data plan associated with the other wireless subscribers, a longevity of a business relationship with the other wireless subscribers, and/or demographic features of the other wireless subscribers.

8. The method of claim 7, wherein the one or more machine learning models are trained by:
splitting the data about the other wireless subscribers into cohort-specific data subsets based on a cohort classification associated with each individual of the other wireless subscribers, and
training the one or more machine learning models using one of the cohort-specific data subsets.

9. The method of claim 1, further comprising determining a value at risk associated with the wireless subscriber, wherein determining the value at risk is based on the determined score and a predicted line churn probability associated with the wireless subscriber.

10. The method of claim 9, wherein the predicted line churn probability is output by an additional machine learning model that is distinct from the one or more machine learning models.

11. A computing system comprising:
a memory configured to store instructions; and
one or more processors configured to execute the instructions to perform operations comprising:
identifying one or more features corresponding to a wireless subscriber associated with a wireless service provider;
predicting, based on the one or more features corresponding to the wireless subscriber and using one or more machine learning models, one or more parameters associated with future engagement of the wireless subscriber with the wireless service provider;
determining a score that is indicative of an expected profitability associated with the wireless subscriber based on the one or more parameters associated with future engagement of the wireless subscriber with the wireless service provider;
determining that the score satisfies a threshold condition; and
responsive to determining that the score satisfies the threshold condition, performing one or more actions to decrease a probability that the wireless subscriber churns.

12. The computing system of claim 11, wherein the one or more parameters associated with future engagement of the wireless subscriber with the wireless service provider comprise:
(i) at least one future payment from the wireless subscriber,
(ii) at least one future cost associated with providing services to the wireless subscriber, and
(iii) at least one future churn probability associated with the wireless subscriber.

13. The computing system of claim 11, wherein the one or more features corresponding to the wireless subscriber comprise historical payments made by the wireless subscriber, historical data usage, historical costs associated with providing services to the wireless subscriber, a type of device of the wireless subscriber, a type of data plan associated with the wireless subscriber, a longevity of a business relationship with the wireless subscriber, and/or demographic features of the wireless subscriber.

14. The computing system of claim 11, comprising:
classifying the wireless subscriber into one of a plurality of cohorts based on the one or more features corresponding to the wireless subscriber, and
selecting the one or more machine learning models for use based on the classification of the wireless subscriber.

15. The computing system of claim 11, wherein the one or more parameters associated with future engagement of the wireless subscriber with the wireless service provider correspond to a length of time between 1 day and 48 months subsequent to the predicting.

16. The computing system of claim 11, wherein the score that is indicative of the expected profitability associated with the wireless subscriber corresponds to a length of time between 1 day and 48 months subsequent to determining the score.

17. The computing system of claim 11, wherein the one or more machine learning models are trained using data about other wireless subscribers, wherein the data comprises historical payments made by the other wireless subscribers, historical data usage, historical costs associated with providing services to the other wireless subscribers, churn rates of the other wireless subscribers a type of device of the other wireless subscribers, a type of data plan associated with the other wireless subscribers, a longevity of a business relationship with the other wireless subscribers, and/or demographic features of the other wireless subscribers.

18. The computing system of claim 17, wherein the one or more machine learning models are trained by:
splitting the data about the other wireless subscribers into cohort-specific data subsets based on a cohort classification associated with each individual of the other wireless subscribers, and
training the one or more machine learning models using one of the cohort-specific data subsets.

19. The computing system of claim 11, further comprising determining a value at risk associated with the wireless subscriber, wherein determining the value at risk is based on the determined score and a predicted line churn probability associated with the wireless subscriber.

20. One or more machine-readable storage devices having encoded thereon computer readable instructions for causing one or more processing devices to perform operations comprising:
identifying one or more features corresponding to a wireless subscriber associated with a wireless service provider;
predicting, based on the one or more features corresponding to the wireless subscriber and using one or more machine learning models, one or more parameters associated with future engagement of the wireless subscriber with the wireless service provider;
determining a score that is indicative of an expected profitability associated with the wireless subscriber based on the one or more parameters associated with future engagement of the wireless subscriber with the wireless service provider;
determining that the score satisfies a threshold condition; and
responsive to determining that the score satisfies the threshold condition, performing one or more actions to decrease a probability that the wireless subscriber churns.
